(19) United States
(12) Patent Application Publication
(10) Pub. No.: US 2024/0194854 A1
(43) Pub. Date: Jun. 13, 2024

(54) RECHARGEABLE ANODE-FREE SODIUM METAL BATTERIES ENABLED BY NON-POROUS SODIUM METAL PLATING AND STRIPPING

(71) Applicant: Washington University, St. Louis, MO (US)

(72) Inventors: Peng BAI, St. Louis, MO (US); Bingyuan MA, St. Louis, MO (US); Youngju LEE, St. Louis, MO (US)

(21) Appl. No.: 18/552,936

(22) PCT Filed: Mar. 30, 2022
(86) PCT No.: PCT/US22/22553

§ 371 Date: Sep. 28, 2023

Related U.S. Application Data
(60) Provisional application No. 63/168,819, filed on Mar. 31, 2021.

(51) Int. Cl. H01M 4/136; H01M 4/04; H01M 10/054; H01M 10/0568; H01M 10/058; H01M 50/411; H01M 50/457

(52) U.S. Cl. CPC H01M 4/136; H01M 4/0438; H01M 10/054; H01M 10/0568; H01M 10/058; H01M 50/411; H01M 50/457

(57) ABSTRACT

The present disclosure is directed to a rechargeable anode-free sodium metal battery including: a cathode substrate; a cathode nanomaterial deposited onto the cathode substrate; a nonaqueous electrolyte, wherein a total water content of the non-aqueous electrolyte is about 10 ppm or less; and an anode substrate, wherein the anode substrate has no deposited material prior to battery recharge, and wherein the anode substrate comprises an ingot-type, non-porous sodium metal surface formed during battery recharge.

### STATEMENT REGARDING FEDERALLY SPONSORED RESEARCH & DEVELOPMENT

This invention was made with government support under CBET1934122 awarded by the National Science Foundation. The government has certain rights in the invention.

### FIELD OF THE DISCLOSURE

The field of the disclosure relates generally to rechargeable anode-free alkali metal batteries. More specifically, the disclosure relates to anode-free sodium metal full cell batteries having dynamic interfacial stability as confirmed by microscopic optical Operando experiments.

### BACKGROUND OF THE DISCLOSURE

Sodium (Na), as one of the most abundant elements on earth, has been considered a sustainable alternative to lithium (Li) for high-performance and low-cost rechargeable batteries. The physical and chemical similarities between these two alkali metals have already inspired promising developments and improvements of Na-ion and room-temperature Na-metal batteries, following the successes of the Li counterparts. Na-metal anodes, without the bulky host structure for ion intercalation, theoretically enable batteries with (theoretical) specific energies as high as 3 to 4 times that of existing Li-ion batteries. However, due to the low redox potential of Na metal, components of the Na-salt non-aqueous electrolytes unavoidably get reduced to form a solid electrolyte interphase (SEI) layer that passivates the Na metal from further reducing the electrolyte, while allowing Na ion to diffuse across and complete the electroplating process. The irreversible SEI layers have been found to quickly accumulate during battery cycling due to the repeated exposure of fresh surfaces of Na metal, leading to low Coulombic efficiency and short cycle life. It also induces heterogeneous ionic flux and surface tension that promote dendritic growths to result in internal shorts.

Various innovations have been made to achieve stable practical sodium metal anodes, including artificial SEI, nanocarbon nucleation layer, scaffold-like current collectors, and solid-state electrolytes. While very thin dendritic Na filaments are avoidable, postmortem analyses of cycled Na metal cells always show clear surface roughness, resembling the morphology of Li whiskers of different widths. Among these approaches, the simple glyme-based electrolytes tested for Na metal anodes appear to enable the best dynamic interfacial stability. However, most recent reports of Na metal cells adopting glyme-based electrolytes either have excess Na metal, or use complex current collectors. The capacity retention rate of anode-free Na metal full cells with only the plain copper current collector on the anode side is still not satisfactory. All these results indicate that a dynamic interfacial stability needs precision diagnosis to identify possible improvement strategies. However, recent in situ and operando studies of Na electroplating frequently observed whisker-like or moss-like porous Na structures, accompanied by suspicious gas evolution.

Accordingly, there is a need for anode-free batteries, such as anode-free sodium metal full cells, that at least demonstrate sufficient dynamic interfacial stability to avoid surface roughness while achieving near theoretical performance with respect to Coulombic efficiency and cycle life.

### BRIEF DESCRIPTION OF THE DISCLOSURE

In one aspect, the present disclosure is directed to a rechargeable anode-free sodium metal battery comprising: a cathode substrate; a cathode nanomaterial deposited onto the cathode substrate; a nonaqueous electrolyte, wherein a total water content of the nonaqueous electrolyte is about 10 ppm or less; and an anode substrate, wherein the anode substrate has no deposited material prior to battery recharge, and wherein the anode substrate comprises an ingot-type, non-porous sodium metal surface formed during battery recharge.

In another aspect, the present disclosure is directed to a method for fabricating a rechargeable anode-free sodium metal battery, the method comprising: depositing sodium metal onto an anode substrate during battery recharge from a nonaqueous electrolyte, wherein a total water content of the nonaqueous electrolyte is about 10 ppm or less; and forming on the anode substrate a continuous, crevice-free, shiny-smooth, non-dendritic, and non-porous sodium metal surface.

In yet another aspect, the present disclosure is directed to a method for characterizing interfacial stability of an electrode, the method comprising: filling a transparent capillary cell with nonaqueous electrolyte, wherein a total water content of the nonaqueous electrolyte is about 10 ppm or less; adding sodium metal to the transparent capillary cell; and applying one-way electroplating with at least one rest.

### BRIEF DESCRIPTION OF THE DRAWINGS

The embodiments described herein may be better understood by referring to the following description in conjunction with the accompanying drawings.

FIG. 1A is an exemplary embodiment of Operando observation of Na electroplating in 1 M NaPF₆-diglyme electrolyte within the capillary cell at an under-limiting current density including a snapshot of the Na metal plating process in accordance with the present disclosure.

FIG. 1B is an exemplary embodiment of Operando observation of Na electroplating in 1 M NaPF₆-diglyme electrolyte within the capillary cell at an under-limiting current density including a snapshot of the Na metal plating process in accordance with the present disclosure.

FIG. 1C is an exemplary embodiment of Operando observation of Na electroplating in 1 M NaPF₆-diglyme electrolyte within the capillary cell at an under-limiting current density including a snapshot of the Na metal plating process in accordance with the present disclosure.

FIG. 1D is an exemplary embodiment of Operando observation of Na electroplating in 1 M NaPF₆-diglyme electrolyte within the capillary cell at an under-limiting current density including a snapshot of the Na metal plating process in accordance with the present disclosure. The snapshot reveals a monolithic piece of shiny smooth Na ingot.

FIG. 2 is an exemplary embodiment of Operando observation of Na electroplating in 1 M NaPF₆-diglyme electrolyte within the capillary cell at an under-limiting current density, including a corresponding voltage response of the Na metal plating process, in accordance with the present disclosure.

FIG. 3A is an exemplary embodiment of the structure of the capillary cells in accordance with the present disclosure.

FIG. 3B is an exemplary embodiment of the deposition and the pristine sodium before removal from the capillary cell in accordance with the present disclosure.

FIG. 3C is an exemplary embodiment of the deposition and the pristine sodium after removal from the capillary cell in accordance with the present disclosure.

FIG. 3D is an exemplary embodiment of a higher magnification image of the sodium deposition in accordance with the present disclosure.

FIG. 4A is an exemplary embodiment of Operando observation of Na electroplating in 1 M NaPF₆-diglyme electrolyte within the capillary cell at an under-limiting current density, including the wrinkle-flattening process on the front facet facing the counter electrode, in accordance with the present disclosure.

FIG. 4B is an exemplary embodiment of Operando observation of Na electroplating in 1 M NaPF₆-diglyme electrolyte within the capillary cell at an under-limiting current density, including the step-moving process along the side of the Na ingot, in accordance with the present disclosure.

FIG. 5A is an exemplary embodiment of Operando observation of Na electroplating in 1 M NaPF₆-diglyme electrolyte within the capillary cell at an under-limiting current density, including non-ideal interfacial stabilities revealing the mossy growth in the 1 M NaPF₆-diglyme electrolyte at moisture levels higher than 10 ppm, in accordance with the present disclosure.

FIG. 5B is an exemplary embodiment of Operando observation of Na electroplating in 1 M NaPF₆-diglyme electrolyte within the capillary cell at an under-limiting current density, including non-ideal interfacial stabilities revealing the picoliter gas bubble in the 1 M NaPF₆-diglyme electrolyte at moisture levels higher than 10 ppm, in accordance with the present disclosure.

FIG. 6 is an exemplary embodiment of snapshots of the sodium metal deposition at an under-limiting current in 1 M NaClO₄-diglyme electrolyte in accordance with the present disclosure.

FIG. 7 is an exemplary embodiment of Na deposition and dissolution in NaPF₆-glyme systems in accordance with the present disclosure. Experiments were done at 2 mA cm⁻².

FIG. 8 is an exemplary embodiment of Na deposition and dissolution in NaClO₄-glyme systems in accordance with the present disclosure. Experiments were done at 2 mA cm⁻².

FIG. 9 is an exemplary embodiment of Na deposition and dissolution in carbonate-based systems in accordance with the present disclosure. Experiments were done at 2 mA cm⁻².

FIG. 10A is an exemplary embodiment of Operando observations of SEI accumulation during cycling at under-limiting current densities, including a 1 M NaClO₄-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10B is an exemplary embodiment of Operando observations of SEI accumulation during cycling at under-limiting current densities, including a 1 M NaClO₄-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10C is an exemplary embodiment of Operando observations of SEI accumulation during cycling at under-limiting current densities, including a 1 M NaClO₄-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10D is an exemplary embodiment of Operando observations of SEI accumulation during cycling at under-limiting current densities, including a 1 M NaClO₄-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10E is an exemplary embodiment of Operando observations of SEI accumulation during cycling at under-limiting current densities, including a 1 M NaClO₄-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10F is an exemplary embodiment of Operando observations of SEI accumulation during cycling at under-limiting current densities, including a 1 M NaClO₄-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10G is an exemplary embodiment of Operando observations of SEI accumulation during cycling at under-limiting current densities, including a 1 M NaClO₄-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10H is an exemplary embodiment of Operando observations of SEI accumulation during cycling at under-limiting current densities, including a 1 M NaPF₆-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10I is an exemplary embodiment of Operando observations of SEI accumulation during cycling at under-limiting current densities, including a 1 M NaPF₆-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10J is an exemplary embodiment of Operando observations of SEI accumulation during cycling at under-limiting current densities, including a 1 M NaPF₆-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10K is an exemplary embodiment of Operando observations of SEI accumulation during cycling at under-limiting current densities, including a 1 M NaPF₆-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10L is an exemplary embodiment of Operando observations of SEI accumulation during cycling at under-limiting current densities, including a 1 M NaPF₆-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10M is an exemplary embodiment of Operando observations of SEI accumulation during cycling at under-limiting current densities, including a 1 M NaPF₆-diglyme electrolyte, in accordance with the present disclosure. Cycling was performed at 2.23 mA cm⁻² with the areal capacity of 3.10 mAh cm⁻², i.e. 10,000 seconds per cycle.

FIG. 10N is an exemplary embodiment of Operando observations of SEI accumulation during cycling at under-limiting current densities, including a 1 M NaPF₆-diglyme electrolyte, in accordance with the present disclosure. Cycling was performed at 2.23 mA cm⁻² with the areal capacity of 3.10 mAh cm⁻², i.e. 10,000 seconds per cycle.

FIG. 11A is an exemplary embodiment of the XPS elemental concentration profiles along the thickness of samples, including stripped-state samples harvested after 10 full cycles, in accordance with the present disclosure. Inset depicts a digital photo of the samples. Experiments were done in 1 M NaPF₆-diglyme electrolyte at 0.5 mA cm⁻². In some embodiments, a conversion rate of 1 nm per minute of sputtering is used to estimate the thickness of SEI.

FIG. 11B is an exemplary embodiment of the XPS elemental concentration profiles along the thickness of samples, including stripped-state samples harvested after 100 full cycles, in accordance with the present disclosure. Inset depicts a digital photo of the samples. Experiments were done in 1 M NaPF₆-diglyme electrolyte at 0.5 mA cm⁻². In some embodiments, a conversion rate of 1 nm per minute of sputtering is used to estimate the thickness of SEI.

FIG. 11C is an exemplary embodiment of the XPS elemental concentration profiles along the thickness of samples, including stripped-state samples harvested after 100 full cycles and thorough rinsing, in accordance with the present disclosure. Inset depicts a digital photo of the samples. Experiments were done in 1 M NaPF₆-diglyme electrolyte at 0.5 mA cm⁻². In some embodiments, a conversion rate of 1 nm per minute of sputtering is used to estimate the thickness of SEI.

FIG. 11D is an exemplary embodiment of the XPS elemental concentration profiles along the thickness of samples, including plated-state samples harvested after completing the first half cycle of plating, in accordance with the present disclosure. Inset depicts a digital photo of the samples. Experiments were done in 1 M NaPF₆-diglyme electrolyte at 0.5 mA cm⁻². In some embodiments, a conversion rate of 1 nm per minute of sputtering is used to estimate the thickness of SEI.

FIG. 11E is an exemplary embodiment of the XPS elemental concentration profiles along the thickness of samples, including plated-state samples harvested after the half cycle of plating following 100 full cycles, in accordance with the present disclosure. Inset depicts a digital photo of the samples. Experiments were done in 1 M NaPF₆-diglyme electrolyte at 0.5 mA cm⁻². In some embodiments, a conversion rate of 1 nm per minute of sputtering is used to estimate the thickness of SEI.

FIG. 11F is an exemplary embodiment of the XPS elemental concentration profiles along the thickness of samples, including plated-state samples harvested after 10 hours of one-way electroplating, in accordance with the present disclosure. Inset depicts a digital photo of the samples. Experiments were done in 1 M NaPF₆-diglyme electrolyte at 0.5 mA cm⁻². In some embodiments, a conversion rate of 1 nm per minute of sputtering is used to estimate the thickness of SEI.

FIG. 11G is an exemplary embodiment of the XPS elemental concentration profiles along the thickness of samples, including an SEM image of the sample shown in FIG. 11D after the first plating step, in accordance with the present disclosure.

FIG. 11H is an exemplary embodiment of the XPS elemental concentration profiles along the thickness of samples, including an SEM image of the sample shown in FIG. 11F after 10 hours of plating, in accordance with the present disclosure.

FIG. 11I is an exemplary embodiment of the XPS elemental concentration profiles along the thickness of samples, including an SEM image of the Na deposits obtained in 1 M NaClO₄-diglyme electrolyte following the same preparation method as for the sample in FIG. 11D, in accordance with the present disclosure.

FIG. 12 is an exemplary embodiment of XPS characterization of the SEI at stripped state after 10 full cycles in 1 M NaPF₆-diglyme electrolyte, corresponding to the samples in FIG. 11A, in accordance with the present disclosure.

FIG. 13 is an exemplary embodiment of XPS characterization of the SEI at stripped state after 100 full cycles in 1 M NaPF₆-diglyme electrolyte, corresponding to the samples in FIG. 11B, in accordance with the present disclosure.

FIG. 14 is an exemplary embodiment of XPS characterization of the SEI at stripped state after 100 full cycles and thorough rinsing in 1 M NaPF₆-diglyme electrolyte, corresponding to the samples in FIG. 11C, in accordance with the present disclosure.

FIG. 15A is an exemplary embodiment of XPS characterization of the SEI at deposited state after completing the first half cycle of deposition in 1 M NaPF₆-diglyme electrolyte, corresponding to the samples in FIG. 11D, in accordance with the present disclosure. The C 1s spectra are shown.

FIG. 15B is an exemplary embodiment of XPS characterization of the SEI at deposited state after completing the first half cycle of deposition in 1 M NaPF₆-diglyme electrolyte, corresponding to the samples in FIG. 11D, in accordance with the present disclosure. The O 1s spectra are shown.

FIG. 15C is an exemplary embodiment of XPS characterization of the SEI at deposited state after completing the first half cycle of deposition in 1 M NaPF₆-diglyme electrolyte, corresponding to the samples in FIG. 11D, in accordance with the present disclosure. The F 1s spectra are shown.

FIG. 15D is an exemplary embodiment of XPS characterization of the SEI at deposited state after completing the first half cycle of deposition in 1 M NaPF₆-diglyme electrolyte, corresponding to the samples in FIG. 11D, in accordance with the present disclosure. The Na 1s spectra are shown.

FIG. 15E is an exemplary embodiment of XPS characterization of the SEI at deposited state after completing the first half cycle of deposition in 1 M NaPF₆-diglyme electrolyte, corresponding to the samples in FIG. 11D, in accordance with the present disclosure. The P 2p spectra are shown.

FIG. 16A is an exemplary embodiment of XPS characterization of the SEI at deposited state after 100.5 cycles in 1 M NaPF₆-diglyme electrolyte, corresponding to the samples in FIG. 11E, in accordance with the present disclosure. The C 1s spectra are shown.

FIG. 16B is an exemplary embodiment of XPS characterization of the SEI at deposited state after 100.5 cycles in 1 M NaPF₆-diglyme electrolyte, corresponding to the samples in FIG. 11E, in accordance with the present disclosure. The O 1s spectra are shown.

FIG. 16C is an exemplary embodiment of XPS characterization of the SEI at deposited state after 100.5 cycles in 1 M NaPF₆-diglyme electrolyte, corresponding to the samples in FIG. 11E, in accordance with the present disclosure. The F 1s spectra are shown.

FIG. 16D is an exemplary embodiment of XPS characterization of the SEI at deposited state after 100.5 cycles in 1 M NaPF₆-diglyme electrolyte, corresponding to the samples in FIG. 11E, in accordance with the present disclosure. The Na 1s spectra are shown.

FIG. 16E is an exemplary embodiment of XPS characterization of the SEI at deposited state after 100.5 cycles in 1 M NaPF₆-diglyme electrolyte, corresponding to the samples in FIG. 11E, in accordance with the present disclosure. The P 2p spectra are shown.

FIG. 17A is an exemplary embodiment of XPS characterization of the SEI at deposited state after 10 hours of one-way deposition in 1 M NaPF₆-diglyme electrolyte, corresponding to the samples in FIG. 11F, in accordance with the present disclosure. The C 1s spectra are shown.

FIG. 17B is an exemplary embodiment of XPS characterization of the SEI at deposited state after 10 hours of one-way deposition in 1 M NaPF₆-diglyme electrolyte, corresponding to the samples in FIG. 11F, in accordance with the present disclosure. The O 1s spectra are shown.

FIG. 17C is an exemplary embodiment of XPS characterization of the SEI at deposited state after 10 hours of one-way deposition in 1 M NaPF₆-diglyme electrolyte, corresponding to the samples in FIG. 11F, in accordance with the present disclosure. The F 1s spectra are shown.

FIG. 17D is an exemplary embodiment of XPS characterization of the SEI at deposited state after 10 hours of one-way deposition in 1 M NaPF₆-diglyme electrolyte, corresponding to the samples in FIG. 11F, in accordance with the present disclosure. The Na 1s spectra are shown.

FIG. 17E is an exemplary embodiment of XPS characterization of the SEI at deposited state after 10 hours of one-way deposition in 1 M NaPF₆-diglyme electrolyte, corresponding to the samples in FIG. 11F, in accordance with the present disclosure. The P 2p spectra are shown.

FIG. 17F is an exemplary embodiment of sample surfaces before XPS (left) and after XPS (right) in accordance with the present disclosure.

FIG. 18A is an exemplary embodiment of the Coulombic efficiency cycled at 0.5 mA cm⁻² and 1 mAh cm⁻² using 1 M NaPF₆-diglyme electrolyte in Cu|Na half-cell in accordance with the present disclosure.

FIG. 18B is an exemplary embodiment of the voltage response cycled at 0.5 mA cm⁻² and 1 mAh cm⁻² using 1 M NaPF₆-diglyme electrolyte in Cu|Na half-cell in accordance with the present disclosure.

FIG. 19 is an exemplary embodiment of XPS characterization of the surface of a piece of fresh Na in accordance with the present disclosure.

FIG. 20A is an exemplary embodiment of XPS characterization of the SEI at deposited state after completing the first half cycle of deposition in 1 M NaClO₄-diglyme electrolyte in accordance with the present disclosure. C 1s spectra are shown.

FIG. 20B is an exemplary embodiment of XPS characterization of the SEI at deposited state after completing the first half cycle of deposition in 1 M NaClO₄-diglyme electrolyte in accordance with the present disclosure. O 1s spectra are shown.

FIG. 20C is an exemplary embodiment of XPS characterization of the SEI at deposited state after completing the first half cycle of deposition in 1 M NaClO₄-diglyme electrolyte in accordance with the present disclosure. Cl 2p spectra are shown.

FIG. 20D is an exemplary embodiment of XPS characterization of the SEI at deposited state after completing the first half cycle of deposition in 1 M NaClO₄-diglyme electrolyte in accordance with the present disclosure. Na 1s spectra are shown.

FIG. 21A is an exemplary embodiment of degradation of half-cells during galvanostatic cycling, including cycling results of Na|Cu half-cells at extreme areal capacities, in accordance with the present disclosure.

FIG. 21B is an exemplary embodiment of voltage responses cycled under 40 mAh cm⁻² at 2 mA cm⁻² using 1 M NaPF₆-diglyme electrolyte in Cu|Na half cell in accordance with the present disclosure.

FIG. 21C is an exemplary embodiment of voltage responses cycled under 20 mAh cm⁻² at 2 mA cm⁻² using 1 M NaPF₆-diglyme electrolyte in Cu|Na half cell in accordance with the present disclosure.

FIG. 22A is an exemplary embodiment of XRD characterization for the Na₃V₂(PO₄)₃(NVP) nanomaterial in accordance with the present disclosure.

FIG. 22B is an exemplary embodiment of SEM characterization for the Na₃V₂(PO₄)₃(NVP) nanomaterial in accordance with the present disclosure.

FIG. 23 is an exemplary embodiment of degradation of full cells during galvanostatic cycling, including voltage profiles for anode-free Cu|NVP full cells at 3C (red) and 2C (blue), in accordance with the present disclosure.

FIG. 24A is an exemplary embodiment of discharge capacity and coulombic efficiency of the Na|NVP half-cell with excess Na, during galvanostatic cycling at 2C, in accordance with the present disclosure. The capacity retention rate per cycle is 99.98%.

FIG. 24B is an exemplary embodiment of degradation of high-loading anode-free full cells during galvanostatic cycling, including cycling performance of the high-loading anode-free Cu|NVP full cells. in accordance with the present disclosure.

FIG. 24C is an exemplary embodiment of degradation of high-loading anode-free full cells during galvanostatic cycling, including selected voltage profiles of the high-loading anode-free Cu|NVP full cells in accordance with the present disclosure.

FIG. 25A is an exemplary embodiment of degradation of full cells during galvanostatic cycling, including discharge capacity and Coulombic efficiency of the anode-free Cu|NVP full cell during galvanostatic cycling at 3C, in accordance with the present disclosure.

FIG. 25B is an exemplary embodiment of degradation of full cells during galvanostatic cycling, including discharge capacity and Coulombic efficiency of the anode-free Cu|NVP full cell during galvanostatic cycling at 2C, in accordance with the present disclosure.

FIG. 25C is an exemplary embodiment of degradation of half-cells during galvanostatic cycling, including an SEM image of the deposits from Na|Cu half-cell after 100 cycles at 3C, in accordance with the present disclosure.

FIG. 25D is an exemplary embodiment of degradation of full cells during galvanostatic cycling, including an SEM image of the deposits from anode-free Cu|NVP full cell after 100 cycles at 3C, in accordance with the present disclosure.

FIG. 25E is an exemplary embodiment of the ingot-type Na metal deposition observed in-situ revealing the ultimate dynamic interfacial stability, which maintains during cell cycling and enables highly stable anode-free Na metal full cells in accordance with the present disclosure.

FIG. 26A is an exemplary embodiment of dynamic interfacial stability of Cu|Na half-cells during cycling, including EIS spectra from 1 to 100 cycles in accordance with the present disclosure.

FIG. 26B is an exemplary embodiment of dynamic interfacial stability of Cu|Na half-cells during cycling, including typical fitting with the proposed equivalent circuit model in accordance with the present disclosure.

FIG. 26C is an exemplary embodiment of dynamic interfacial stability of Cu|Na half-cells and Cu|NVP full cells during cycling, including decoupling of the SEI and charge transfer resistances at low temperatures in accordance with the present disclosure. The freezing point of the 1 M NaPF₆-diglyme electrolyte was tested to be −8.2° C.

FIG. 26D is an exemplary embodiment of dynamic interfacial stability of Cu|Na half-cells and Cu|NVP full cells during cycling including comparison of the interface resistance in accordance with the present disclosure.

FIG. 26E is an exemplary embodiment of dynamic interfacial stability of Cu|Na half-cells during cycling including the corresponding voltage profile in accordance with the present disclosure.

FIG. 26F is an exemplary embodiment of dynamic interfacial stability of Cu|NVP full cells during cycling including EIS spectra from 1 to 100 cycles in accordance with the present disclosure.

FIG. 26G is an exemplary embodiment of dynamic interfacial stability of Cu|NVP full cells during cycling including typical fitting with the proposed equivalent circuit model in accordance with the present disclosure. Bisquert is a modified transmission line model for Warburg impedance fitting.

FIG. 26H is an exemplary embodiment of dynamic interfacial stability of Cu|NVP full cells during cycling including the corresponding voltage profile in accordance with the present disclosure.

FIG. 26I is an exemplary embodiment of dynamic interfacial stability of Cu|Na half-cells and Cu|NVP full cells during cycling including comparison of the uncompensated resistance in accordance with the present disclosure.

FIG. 27A is an exemplary embodiment of a snapshot showing the transition of growth mechanism at an over-limiting current density in accordance with the present disclosure. Dashed line indicates the Sand's time, at which the transition happened.

FIG. 27B is an exemplary embodiment of an optical image of an opened cell after penetration in accordance with the present disclosure.

### DETAILED DESCRIPTION OF THE DISCLOSURE

Rechargeable alkali metal anodes hold the promise to significantly increase the energy density of current battery technologies. However, they are plagued by dendritic growths and solid-electrolyte interphase (SEI) layers that undermine the battery safety and cycle life. Disclosed herein for the first time is a non-porous ingot-type sodium metal growth with self-modulated shiny-smooth interface that are cycled reversibly, without forming whiskers, mosses, gas bubbles or disconnected metal particles typically observed. The ideal dynamic interfacial stability confirmed in the microcapillary cells is the key to enable anode-free Na metal full cells with a capacity retention rate of 99.93% per cycle, superior to available anode-free Na and Li batteries using liquid electrolytes. Contradictory to the common beliefs established around alkali metal anodes, there is no repeated SEI formation on or within the sodium anode, supported by the X-ray photoelectron spectroscopy elemental depth profile analyses, electrochemical impedance spectroscopy diagnosis and microscopic imaging.

As described herein, operando experiments and observations of the present disclosure enable a dynamic characterization of the rechargeable anode-free sodium metal batteries of the present disclosure, as opposed to conventional postmortem characterizations. Postmortem characterizations are performed on the disassembled battery, such that the interface of the electrode is no longer in a dynamic working condition. Therefore, interfacial stability is much more accurately characterized in the present disclosure precisely because it is a dynamic interfacial stability characterization.

Accordingly, disclosed herein for the first time is a self-modulated shiny-smooth non-porous Na metal deposit grown from unpolished rough surfaces, in glyme-based liquid electrolytes. This ideal dynamic interfacial stability confirmed in the operando microcapillary cell experiments described herein enables anode-free full cells that are capable of delivering>93.4% of the initial capacity after 100 cycles of galvanostatic cycling at 3C (equivalent to 0.75 mA cm⁻²), yielding a Na inventory retention rate (NIRR) of 99.93% per cycle. Further, while controlling the moisture level of the electrolyte is critically important, the obtained superior performance is attributed to the lack of repeated formation and accumulation of SEI layers on Na metal deposits, corroborated by the nearly invariable interfacial impedance, and reflected by the high efficiencies in both half- and full cells. The comparative electrochemical impedance spectroscopy (EIS) analyses of half- and full cells during cycling proved that the cathode electrolyte interphase (CEI) layers, rather than SEIs on the anode, dominate the cell degradation.

### Results

Self-modulated shiny-smooth Na ingots. Glass capillary cells were fabricated to investigate the growth mechanisms of Na metal anode, which allow for both the straightforward observation of the morphological evolution as well as the accurate determinations of the actual current density and characteristic physical constants. It is worth noting that according to the definition of electroplating, the working electrode is conventionally called the cathode. However, following the naming convention of batteries, the Na electrode was designated as the anode. The cathodic electroplating process occurs on the Na metal “anode” during the battery recharge process.

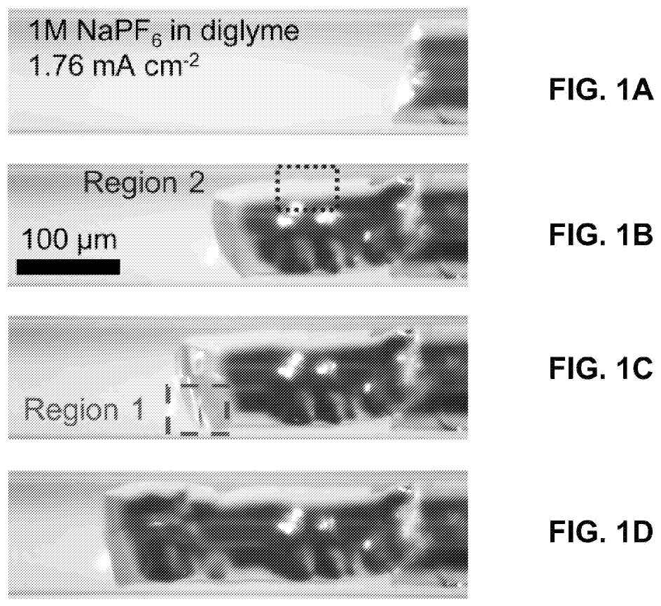

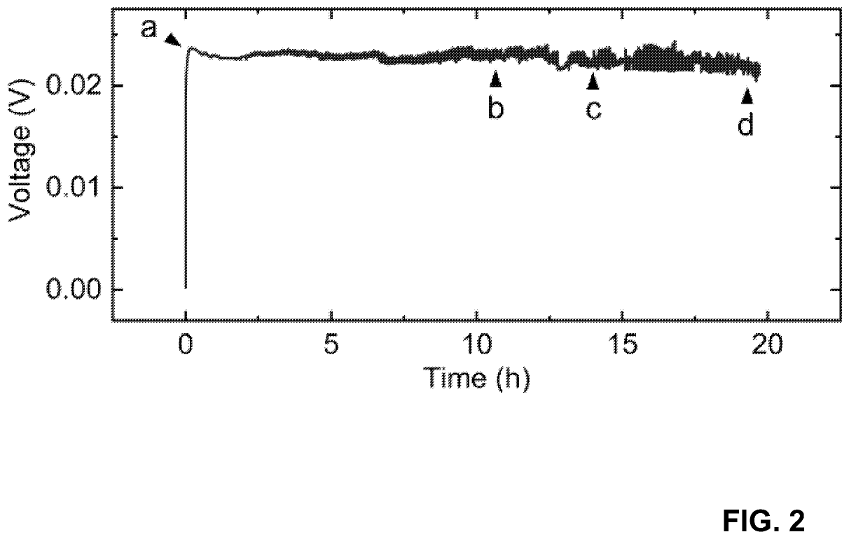

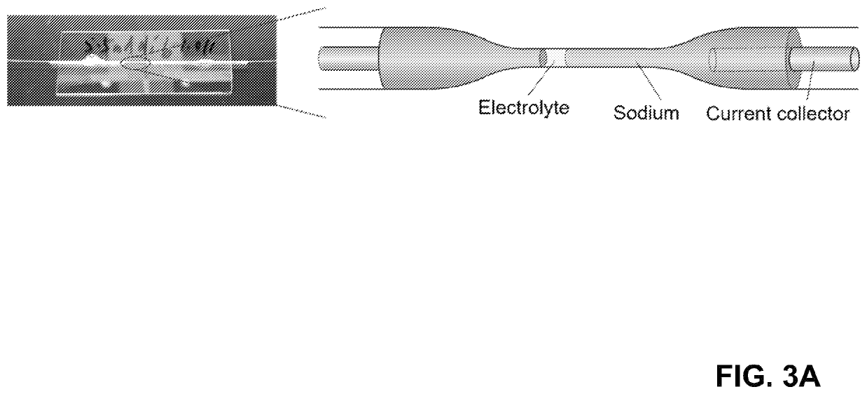

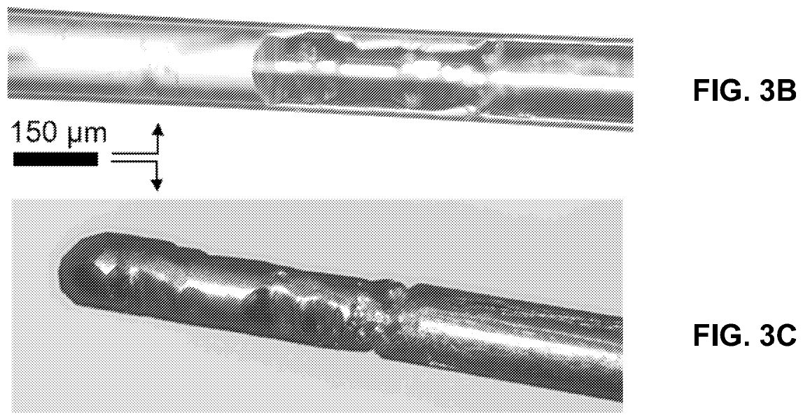

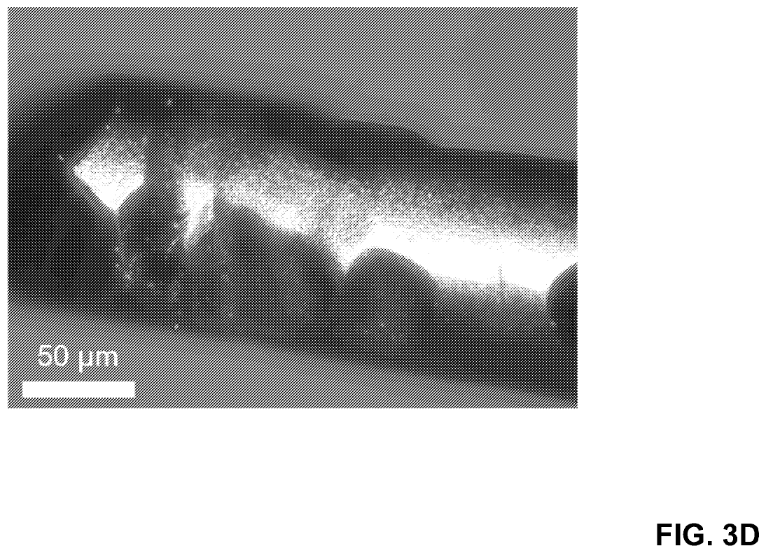

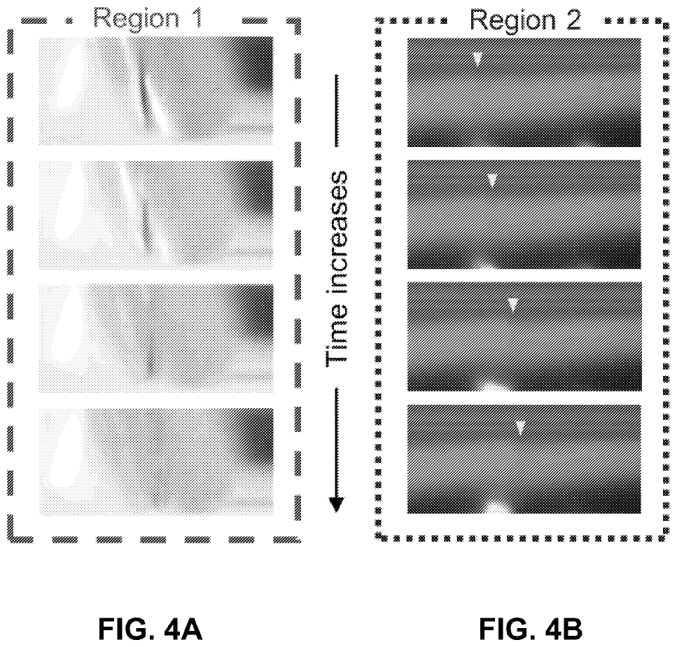

In contrast to the highly porous Na deposits and Li deposits reported in the literature, the snapshots shown in FIGS. 1(A-D) clearly reveal an ingot of Na, i.e. a non-porous solid piece of Na metal with shiny-smooth surfaces, “filling up” the capillary. See also FIG. 2 and FIGS. 3(A-D). It is worth noting that the initial surface of the electrode has clear deep crevices, however the growth self-modulates itself into a shiny-smooth monolithic piece. In addition to the macroscopic smooth facets that easily reflect the illumination, two microscopic characteristic growth processes were identified. The first is the wrinkle-flattening process on the front facet facing the counter electrode (FIG. 4A), and the other is the step-moving process along the side of the ingot (FIG. 4B). The observed classical layer-by-layer step-moving mechanism clearly supports the formation of a smooth Na ingot.

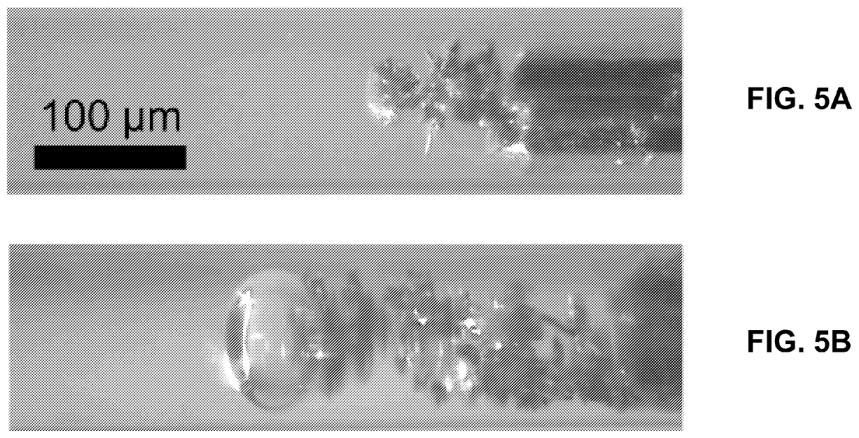

It is important to note that Na is more sensitive to the trace amount of water in the nonaqueous electrolytes than Li is. In some embodiments and examples disclosed herein, the moisture level of the electrolyte must be lower than about 10 ppm or lower than 10 ppm, to consistently get the ingot-type shiny-smooth non-porous Na metal growths. In some embodiments, the moisture level of the electrolyte is lower than about 10 ppm, lower than 10 ppm, lower than about 7 ppm, lower than 7 ppm, lower than about 5 ppm, lower than 5 ppm, lower than about 3 ppm, lower than 3 ppm, lower than about 1 ppm, or lower than 1 ppm. The ideal dynamic interfacial stability, reflected by the ingot-type growths, disappears when the moisture level in the same NaPF₆-diglyme electrolyte is slightly increased (FIG. 5A). Pico-liter sized gas bubbles that cannot be detected by other methods emerge when the moisture level is slightly higher, especially after galvanostatic cycling (FIG. 5B). While a systematic investigation of the effects of trace amount of moisture and the reaction pathways of gas evolution is important and necessary, the present disclosure focuses on the assessment of the system with the ideal dynamic interfacial stability to demonstrate the possibility of high-retention-rate anode-free full cells, which is of great practical importance.

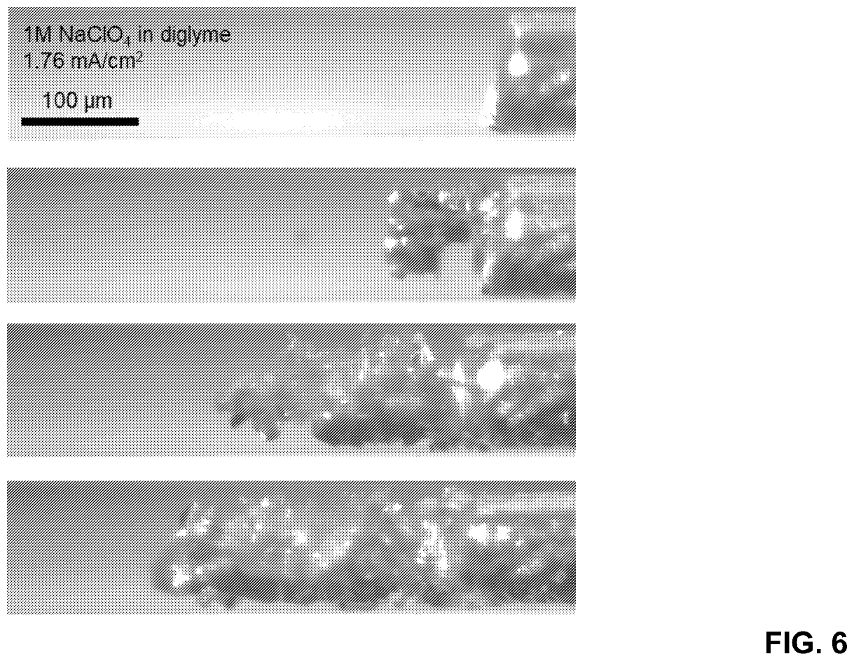

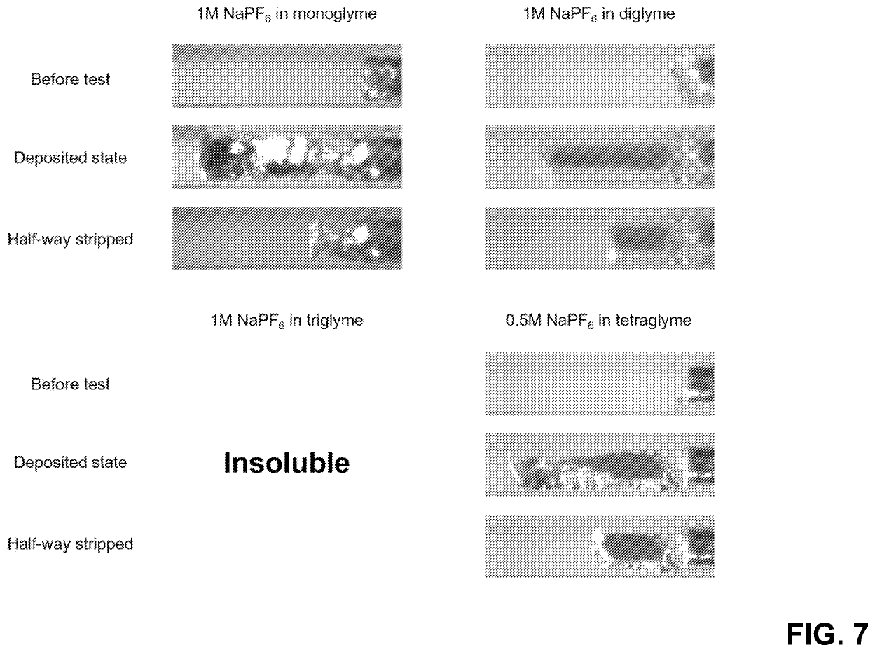

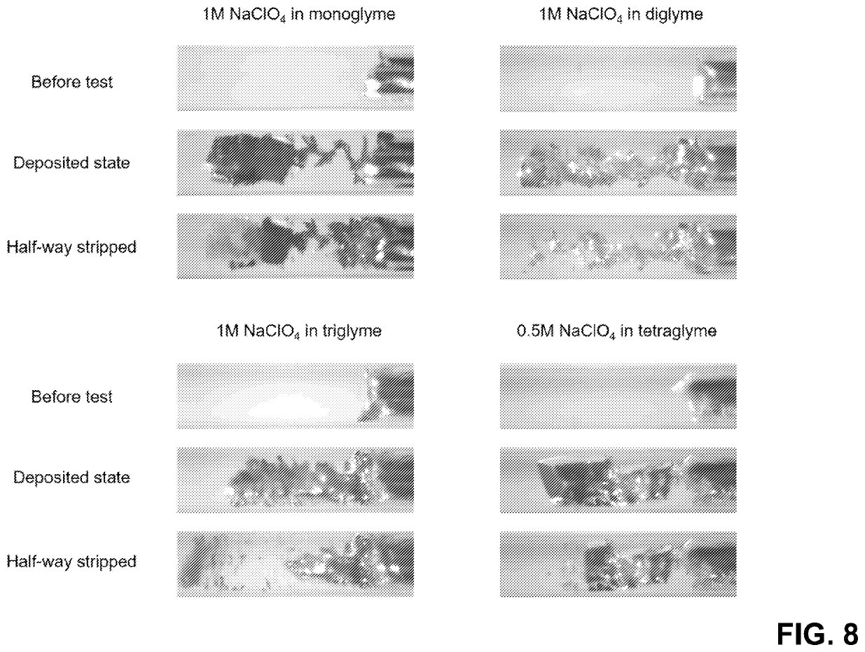

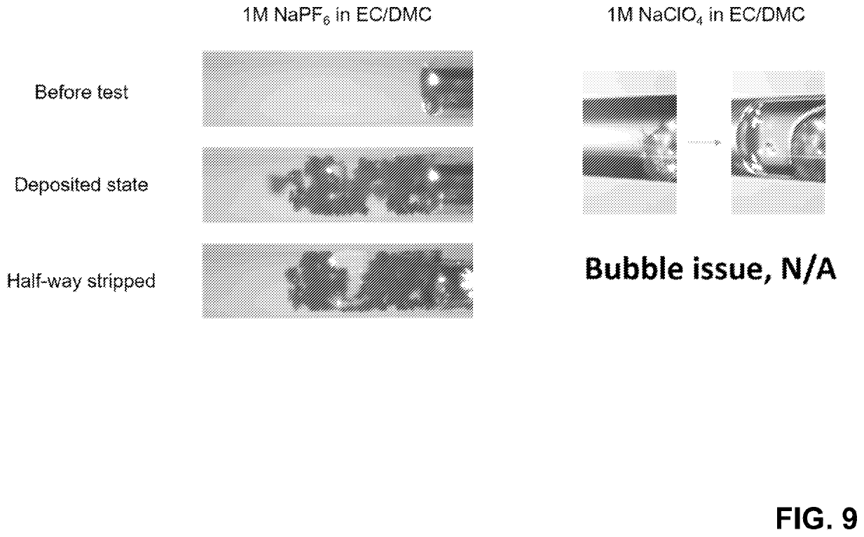

Even under the careful control of the moisture level, this ingot-type Na deposit was only observed in electrolytes of specific combinations of salt and solvent. Replacing NaPF₆ with NaClO₄ leads to similar whisker-free Na deposits, however with a much rougher side surface (FIG. 6). Changing the solvent from glymes to typical carbonate mixtures (e.g. ethylene carbonate and dimethyl carbonate widely used in Li-salt electrolytes) clearly promotes Na whisker/moss growths, regardless of the type of Na salts (FIGS. 7-9). The drastically different morphologies appear to suggest that, the SEI layers formed on Na in the NaPF₆-glyme electrolytes did not follow the current wisdom established on the SEIs formed on alkali metal anodes in ether- or carbonate-based electrolytes. From the physical perspective, the SEI layers formed in NaPF₆-diglyme electrolyte must be ionically and electrically “thin” enough that both Na ions and electrons are readily available everywhere to enable the step-moving growth mechanism observed here (FIGS. 1(A-D) and FIG. 2), which was never observed in Li electroplating, nor in Na plating in other electrolytes. Yet, the thin SEI layers must be either flexible enough that no mechanical stress is built up underneath, or strong enough that no pinholes are created in the SEI layers, such that the “soft” Na metal cannot be “squeezed out” as root-growing whiskers. The surprising observations appear to suggest yet another possibility that no SEI layers were accumulated on the Na metal surface, just as no SEI coverages formed on the compact metal deposits obtained in aqueous solutions, in which the classic step-moving mechanism was established.

Due to the low redox potentials, the chemical passivation of alkali metal anodes in nonaqueous electrolytes occurs spontaneously, without the need of passing the current. To allow chemical reaction to prevail, interrupting the Na plating process with long-time rests, instead of keeping the system in an all-time dynamic electrochemical process, in some embodiments allows the SEI layers to grow thicker or evolve into a more stable state, after which the morphology of Na deposits in some embodiments becomes different. To test this possibility, transparent capillary cells were fabricated to perform one-way electroplating with rests. After a plating process at 1.85 mA cm⁻² for 10 hours, the capillary cell was put into rest for 8 hours, a typical resting time for cell phone or electric car batteries, i.e. during idling or parking. When the plating was resumed with the same current density, the new growth simply continued the step-moving process from where it had been stopped, without creating any visible marks on the side surface of the shiny-smooth Na ingot. No visible marks were found even after a second rest of 16 hours.

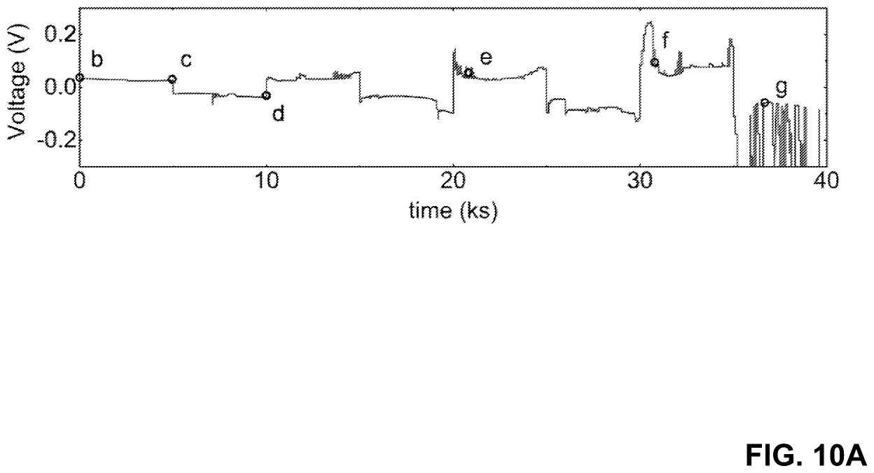

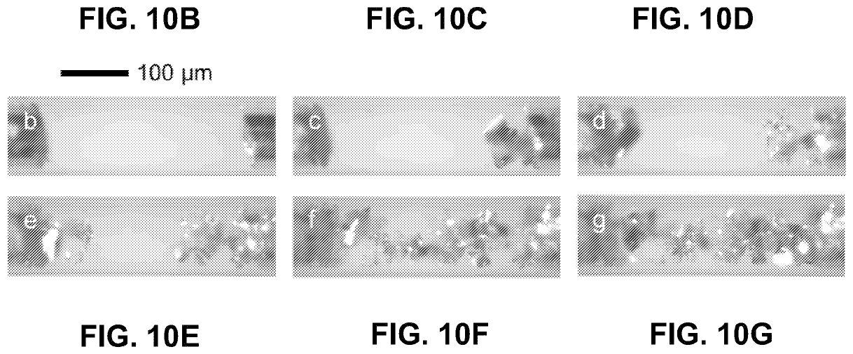

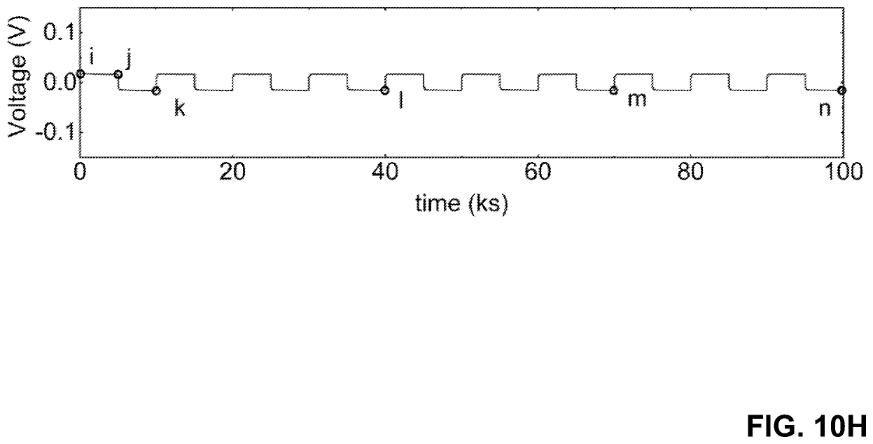

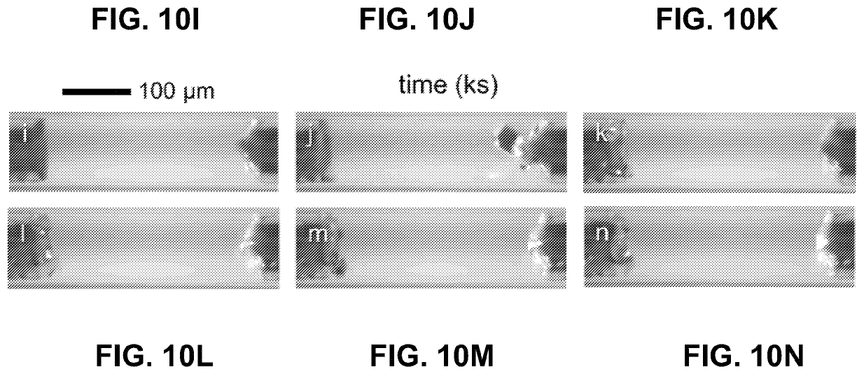

Visual inspections of the SEI accumulation. The transparent capillary cells described herein offer the direct test of whether inactive SEI layers will trap Na particles and accumulate during plating-stripping cycling. Symmetrical Na|Na capillary cells with an inter-electrode separation of ˜380 m were fabricated and cycled at constant under-limiting current densities. As shown in FIGS. 10(A-N), while the cells using 1 M NaClO₄-diglyme electrolyte form similarly smooth Na deposits during the first plating step, some transparent structures (SEI sleeves/gloves) with trapped shiny Na particles were left in the bulk electrolyte after the completion of the first stripping step (FIGS. 10(A-G)). The structures quickly accumulate on both electrodes upon cycling, leading to an interpenetrating structure and large voltage fluctuations. The results clearly explain the low Coulombic efficiency of this chemistry, and are consistent with the prevailing belief that repeated formation of SEI layers on newly exposed metal surfaces continuously reduce the electrolyte and trap disconnected metals to yield a low Coulombic efficiency.

In stark contrast, capillary cells using 1 M NaPF₆-diglyme electrolytes do not produce similar residual SEI structures (with trapped Na particles) observable under optical microscope (FIGS. 10(H-N)). The deposits always appear shiny smooth without forming any disconnected Na particles or flotsams. The corresponding transient voltages were stable.

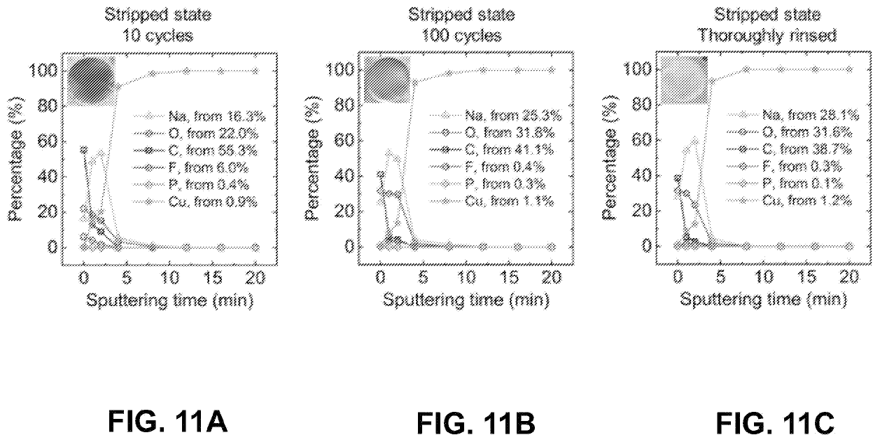

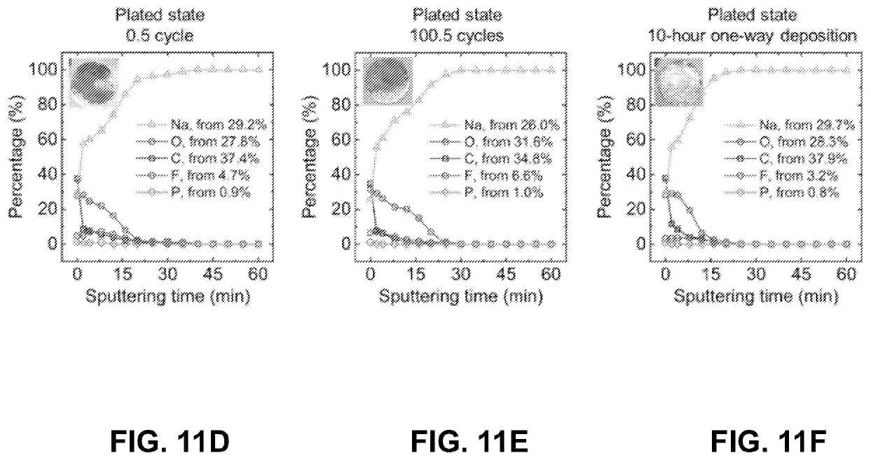

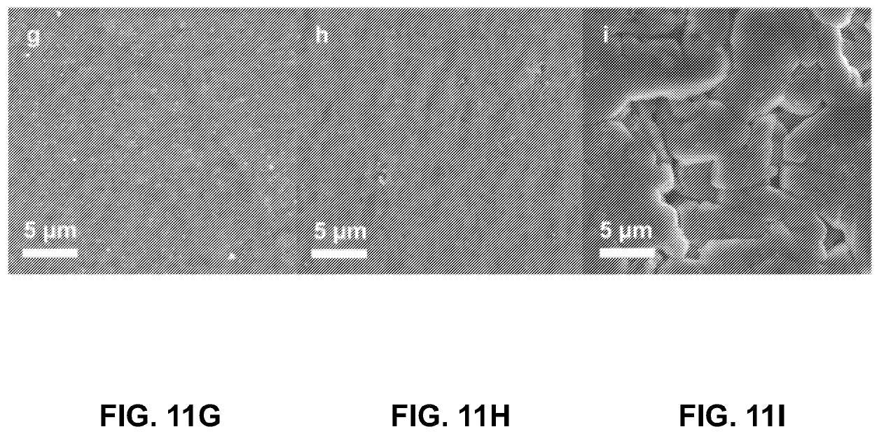

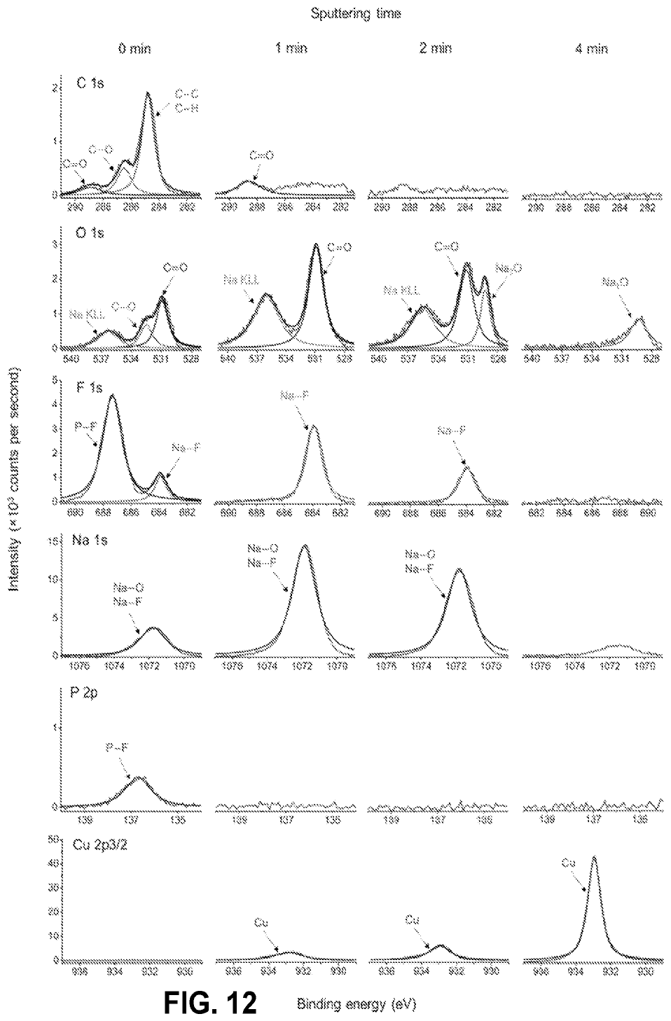

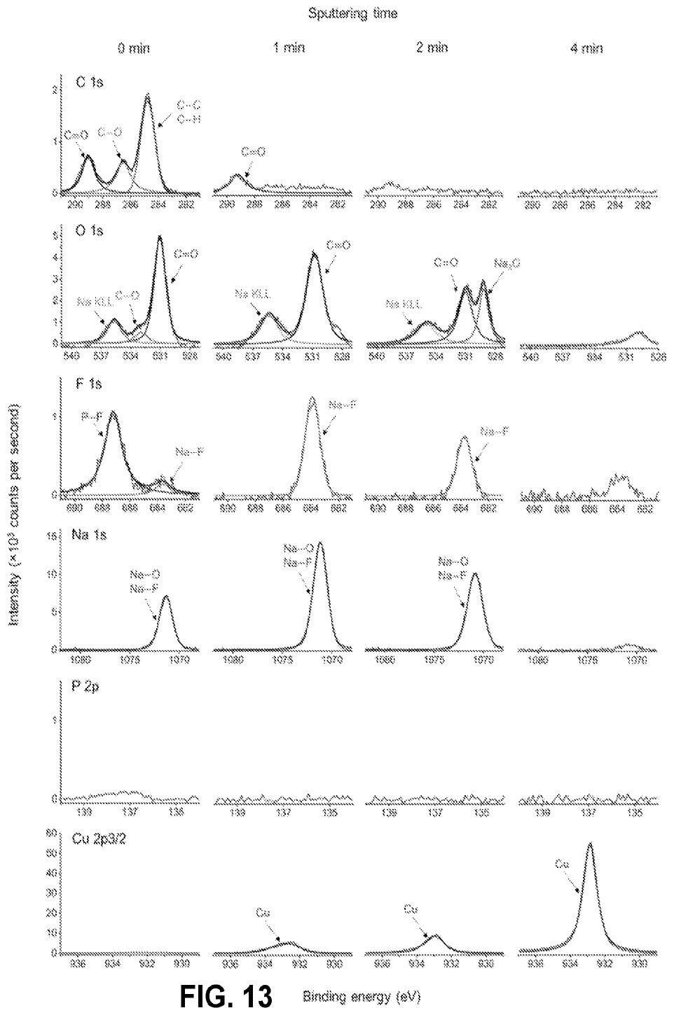

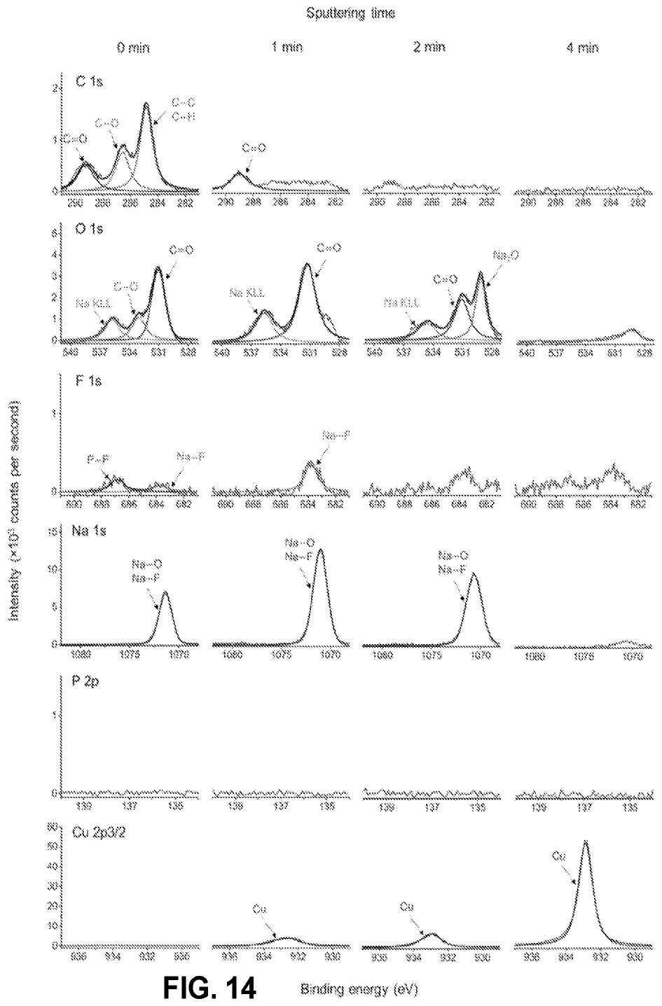

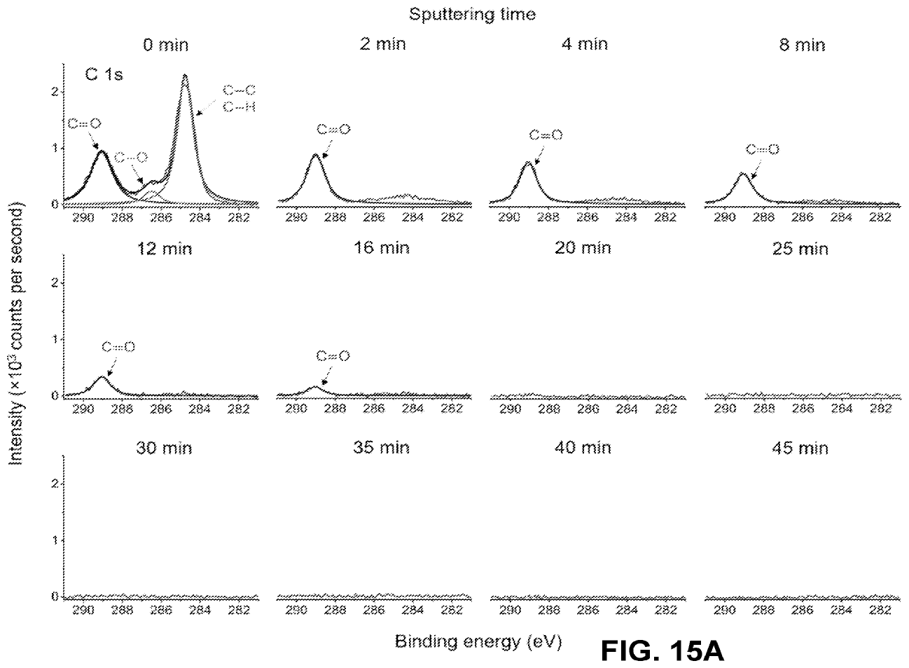

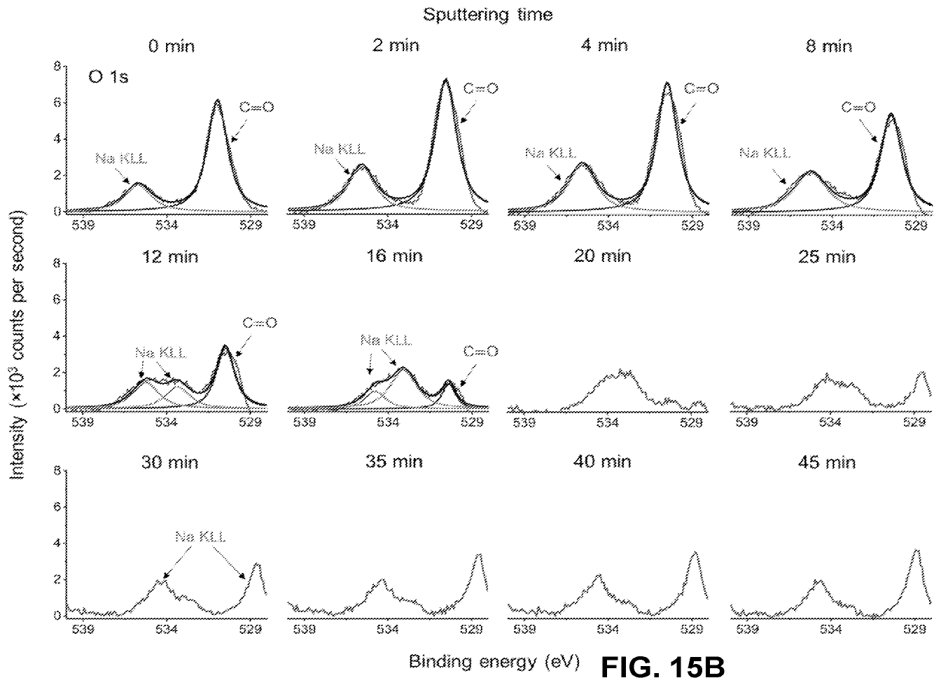

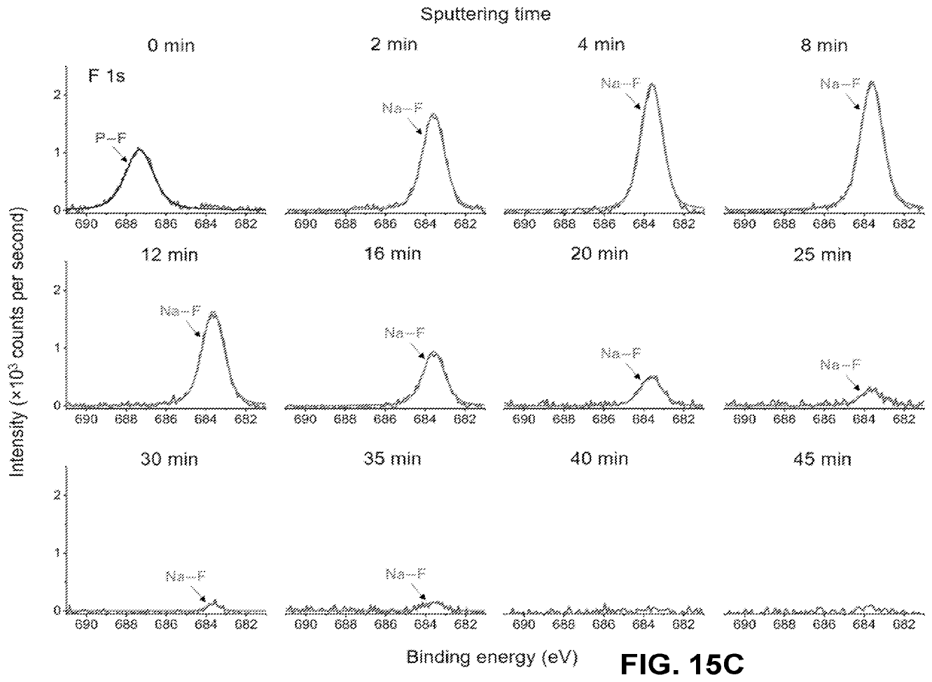

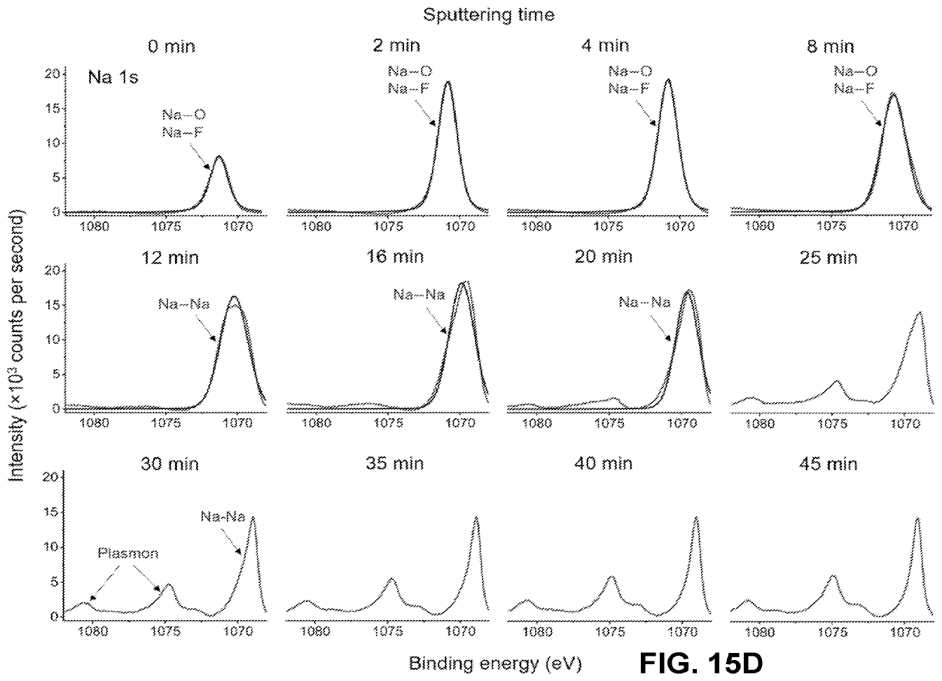

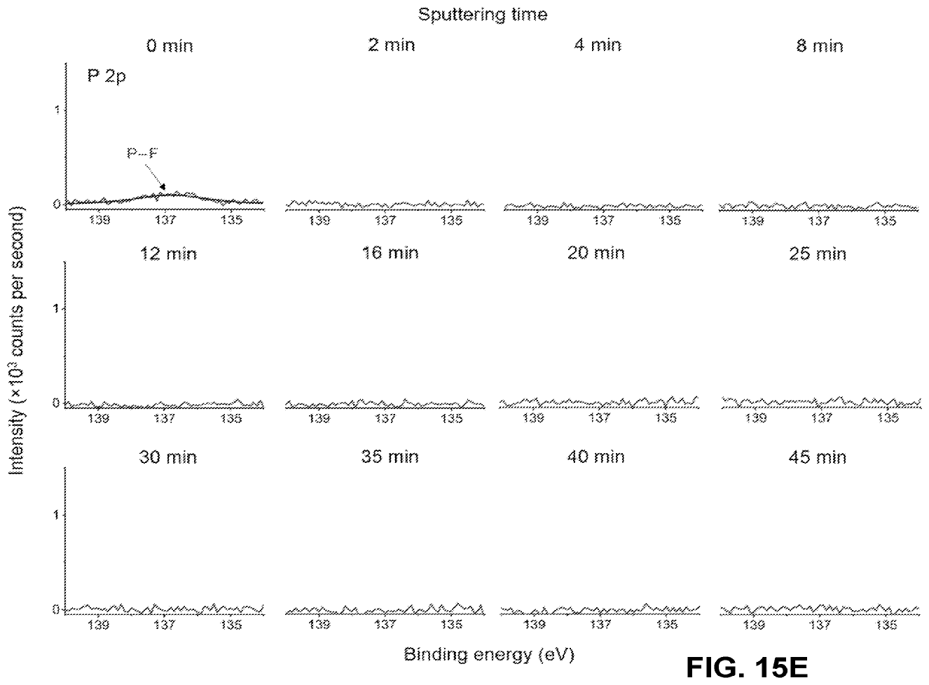

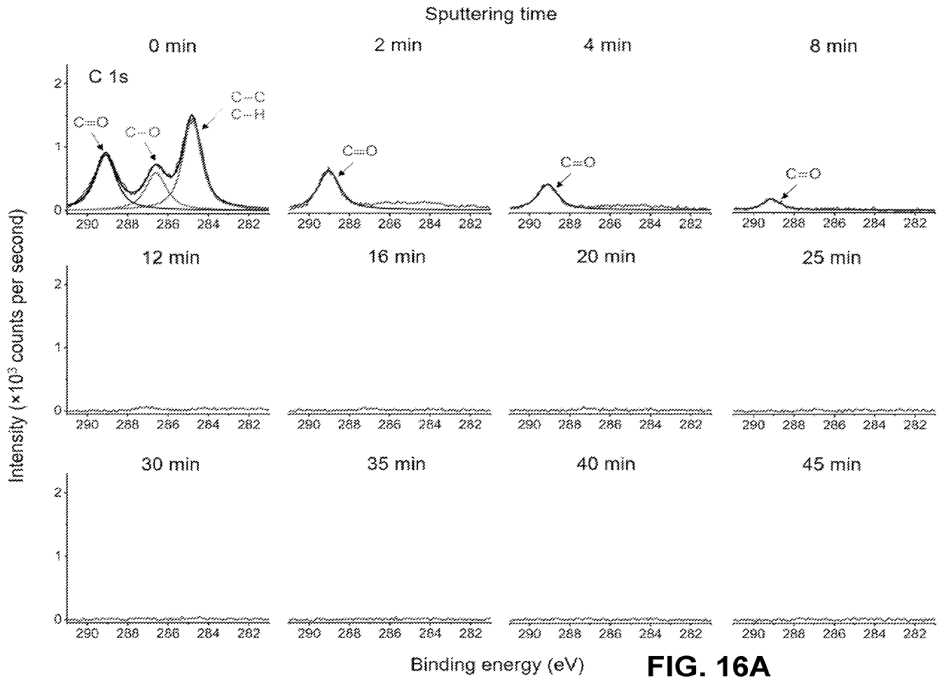

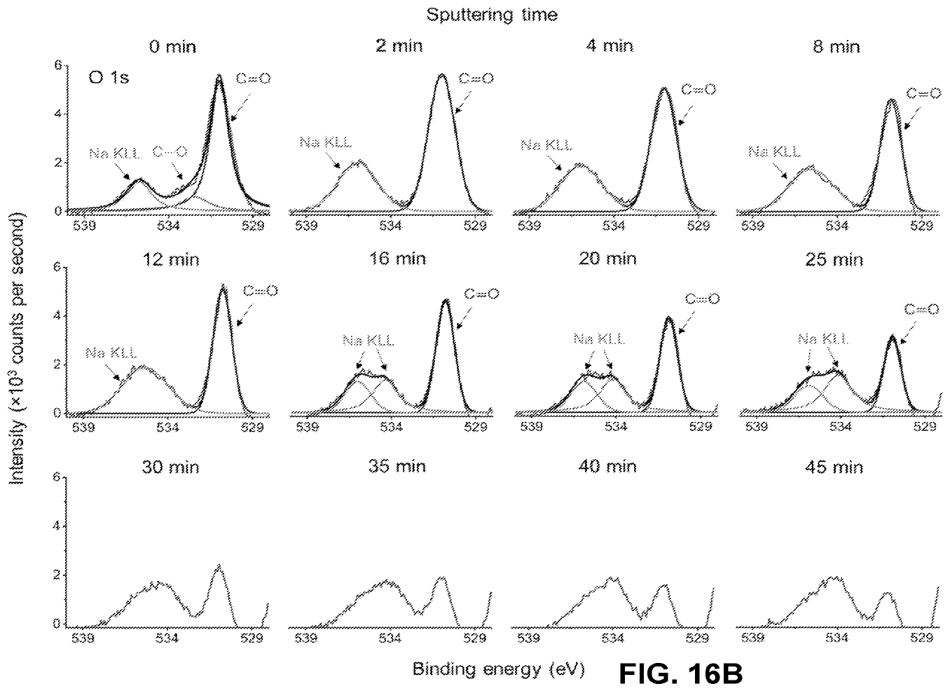

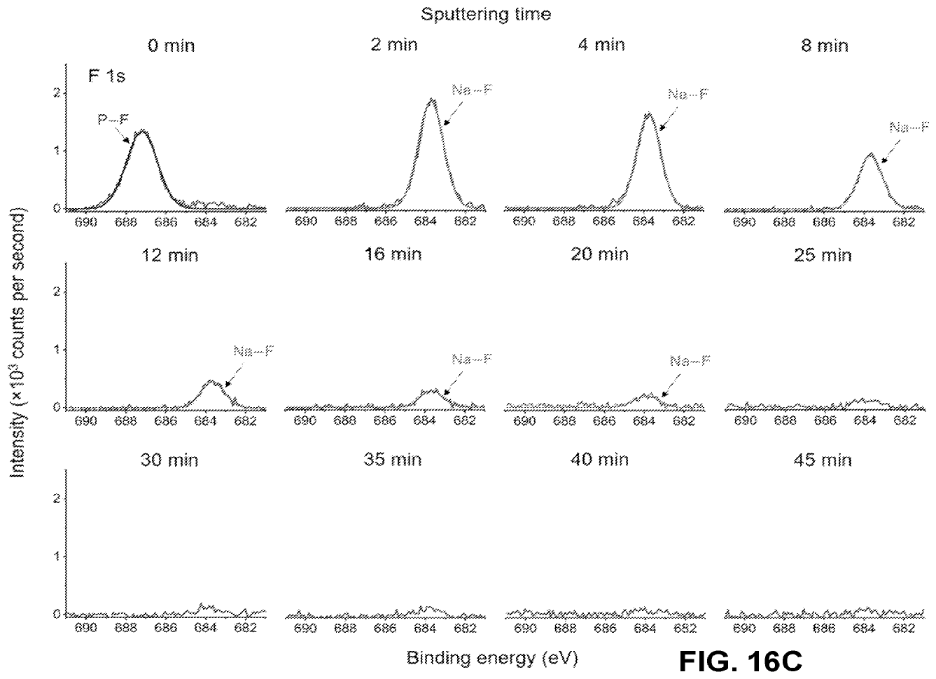

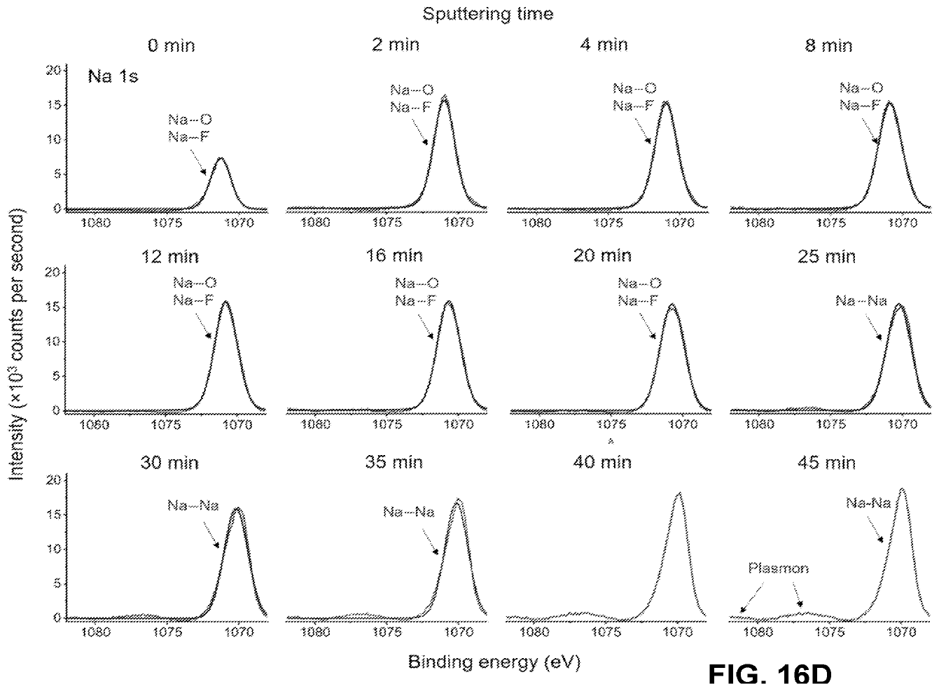

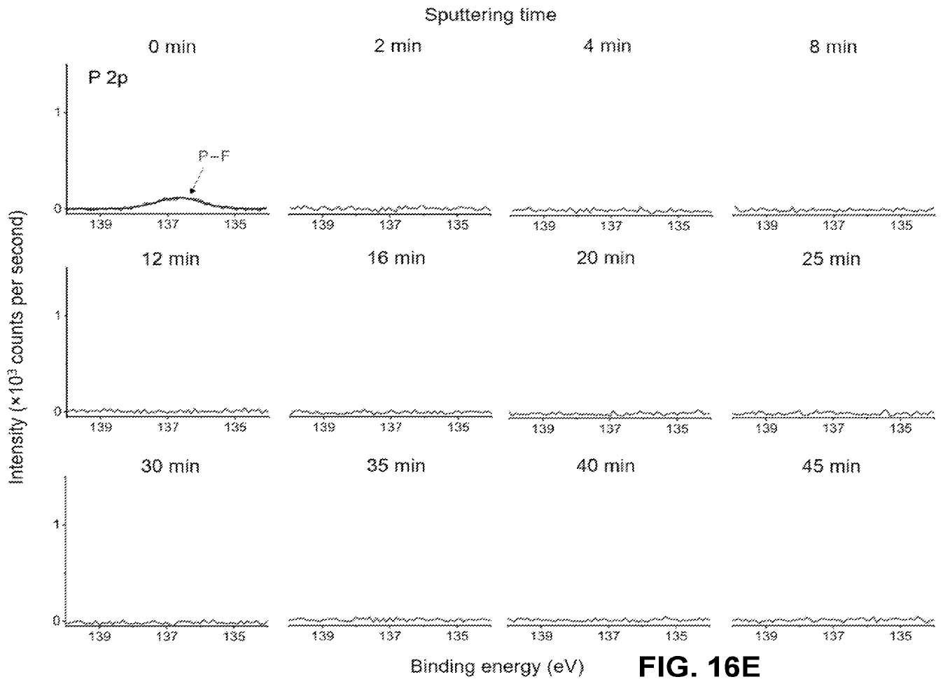

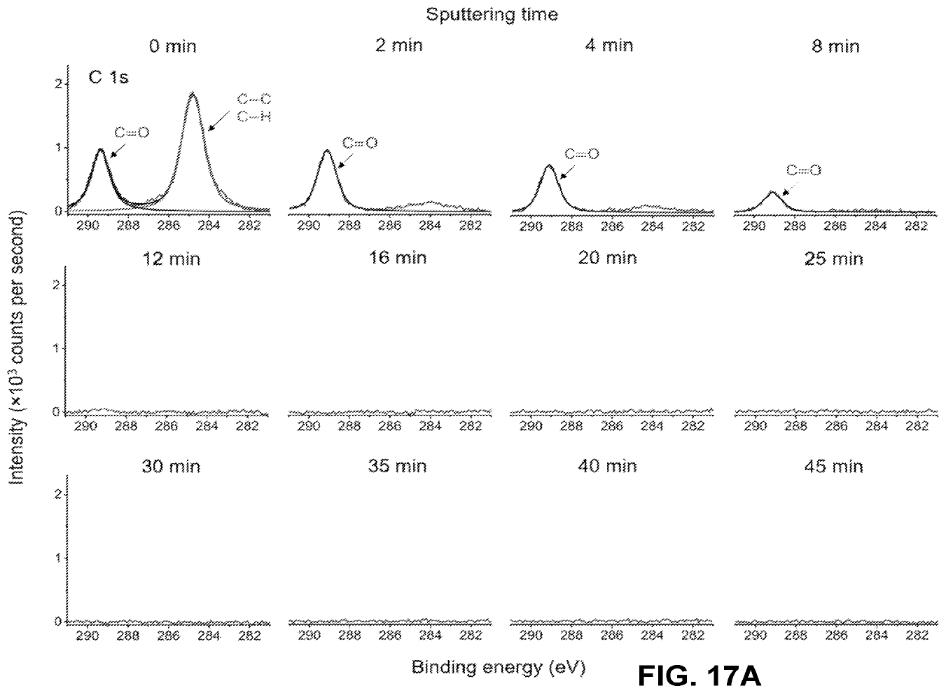

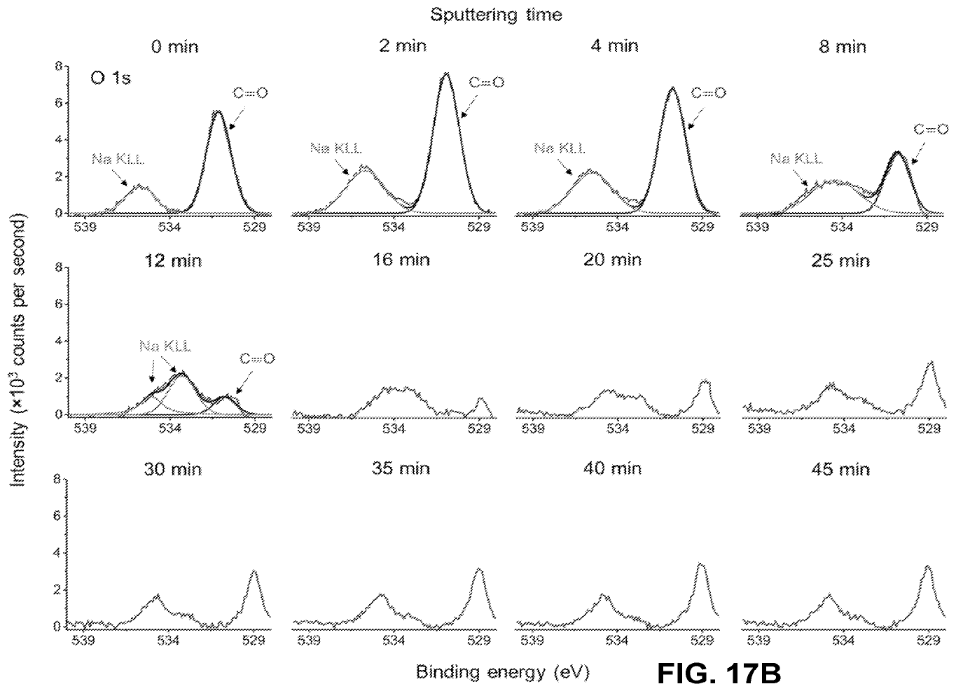

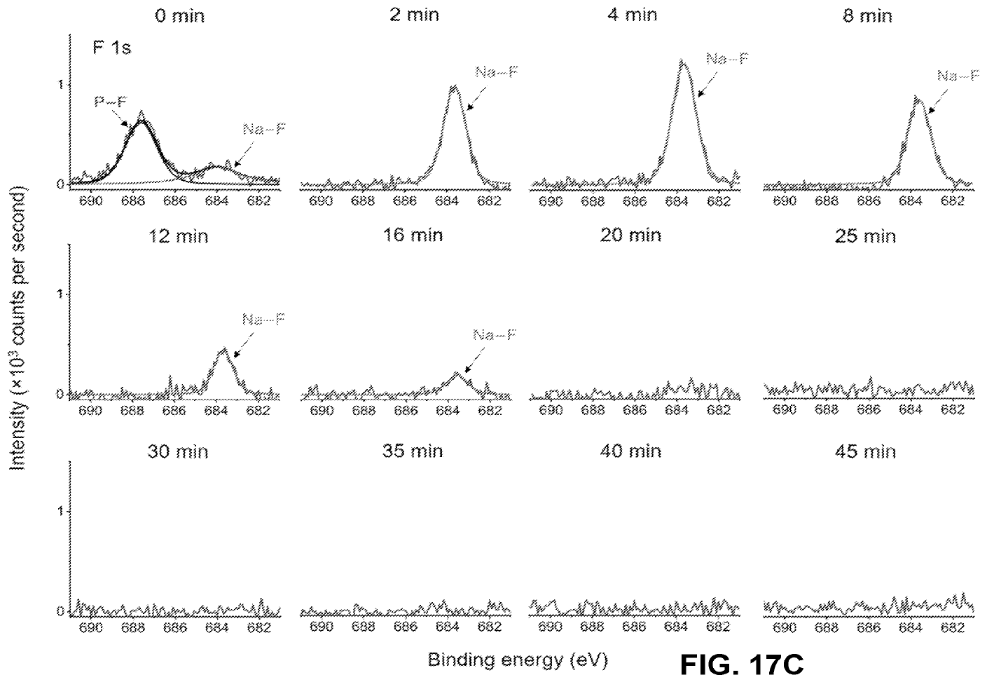

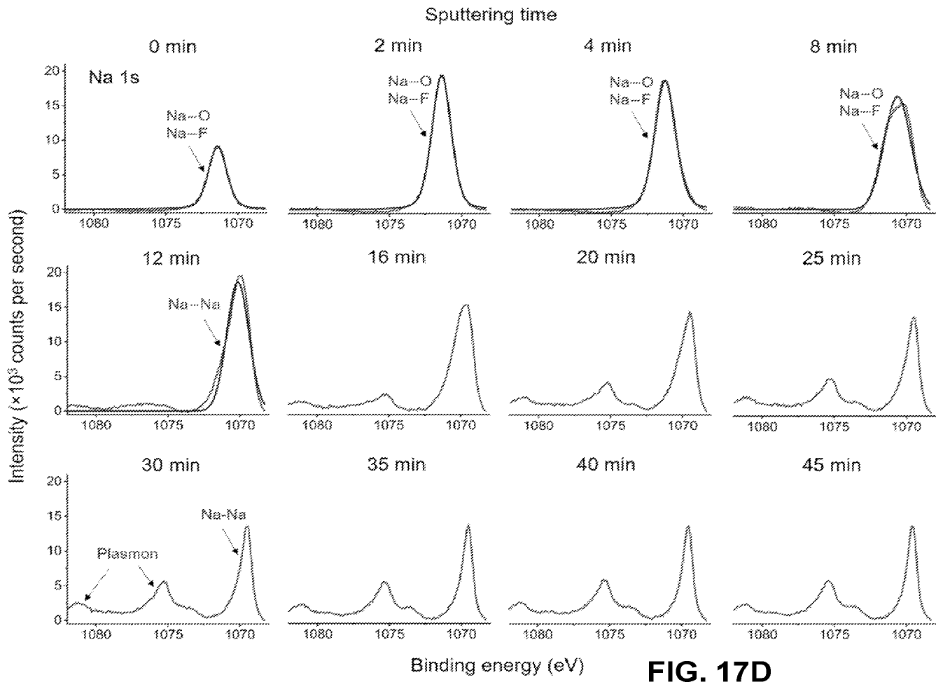

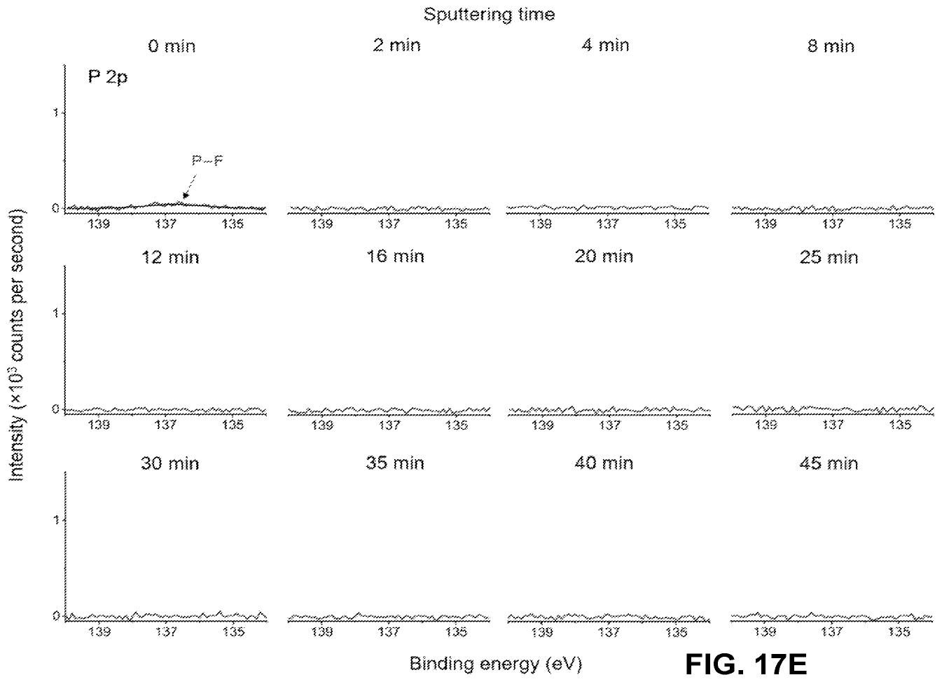

Chemical characterizations of the SE layers. Details at scales lower than 1 am, which were not revealed from the operando optical microscopy experiments, were supported by the chemical characterization of the surface layers. Cu|Na cells were then fabricated in a practical sandwich structure using stainless steel coin cells. Samples in both the stripped and plated states were harvested and characterized by X-ray photoelectron spectroscopy (XPS) with depth profiling to identify the electrolyte reduction products, as summarized in FIGS. 11(A-I). The corresponding XPS spectra is shown in FIG. 12, FIG. 13, FIG. 14, FIGS. 15(A-E), FIGS. 16(A-E), and FIGS. 17(A-E), with peak assignments listed in Table 1. Sample surfaces before (left) and after (right) XPS are shown in FIG. 17F.

TABLE 1
Binding energy and the peak assignments of the SEI component

| Element | Binding energy (eV) | Peak assignment | Species |
|---|---|---|---|
| C 1s | 284.8 | C—C, C—H | RH₂ONa |
| | 286.5 | C—O | RH₂ONa |
| | 288.9 | C═O | Na₂CO₃ |
| 0 1s | 529.3 | Na—O | Na₂O |
| | 530.9 | C—O | Na₂CO₃ |
| | 532.5 | C—O | RH₂ONa |
| | 533-537 | Na KLL | — |
| F 1s | 683.9 | Na—F | NaF |
| | 687.3 | P—F | NaₓPF_{y}, |
| | | | NaₓPO_{y}F_{z} |
| Na 1s | 1071.8 | Na—O, Na—F | Na₂O, NaF, |
| | 1070.1 | Na—Na | Na metal |
| P 2p | 136.7 | P—F | NaₓPF_{y}, |
| | | | NaₓPO_{y}F_{z} |
| Cu 2p3/2 | 932.9 | Cu | Cu |

Assignments in Table 1 represent the prevailing choices with confirmations in the literature. While peak assignments for samples in the stripped state (without metallic Na) are relatively straightforward to make, interpretations of XPS data for samples in the plated state (with Na metal) are intrinsically difficult, due to not only the overlapping between the O spectra with the Na KLL peaks, but also the fast reaction between Na and the possible trace amount of O₂ during the transfer and characterization processes, even though the sample was transferred in a standard air-tight holder and a high vacuum was always maintained during the XPS characterization. For the O 1s spectra, the peak at 529.3 eV is consistent with the Na—O peak from Na₂O. The peak that has the strongest intensity at 530.9 eV was assigned to C═O, instead of Na—O, indicating the outer Na₂O layer further reacted with moisture and CO₂. The small peak at 532.5 eV is therefore assigned to C—O. The depth profiles of C—O and C═O from O 1s spectra are consistent with those from the C 1s spectra. Peaks located higher than 533 eV were assigned as Na KLL peaks, rather than C—O, as the binding energies for metal oxides were suggested to be lower than this value.

The Cu|Na cells were cycled at 0.5 mA cm⁻², with a deposited areal capacity of 1 mAh cm⁻² in each cycle. The XPS depth profiling shown in FIG. 11A reveals the elemental composition of the residual SEI layers left on the Cu current collect after 10 full cycles. Elements from the electrolyte decay to a negligible level in just 4 minutes of sputtering, which confirms a very thin SEI layer, consistent with previous observation. Surprisingly, however, the SEI layers did not accumulate as the cycle number increases. The Cu current collector harvested from coin cells after 100 full cycles reveal the same thickness of the remaining SEI layers (FIG. 11B). This thickness appears also independent from the rinsing time of the sample (FIG. 11C). The high Coulombic efficiency indicates that electrical charges used for SEI formation were negligibly low (FIGS. 18(A-B)), supporting the XPS results.

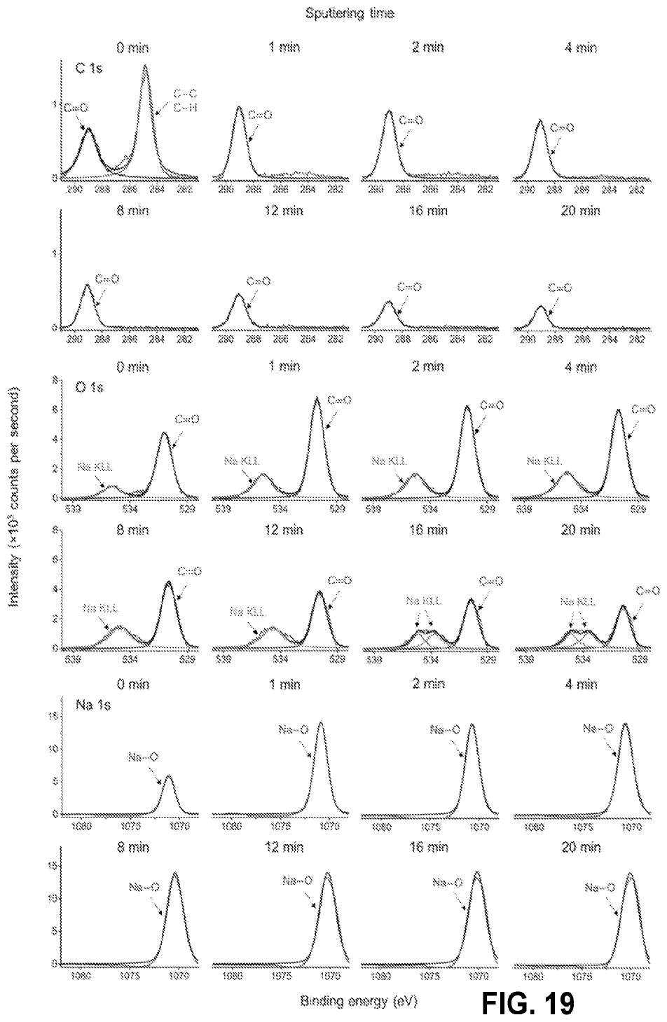

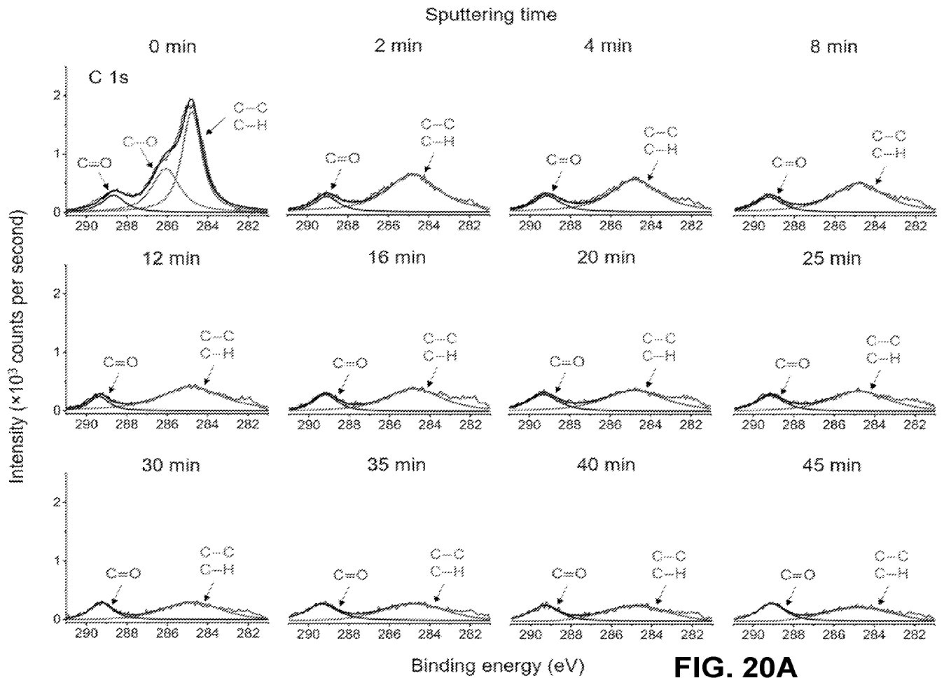

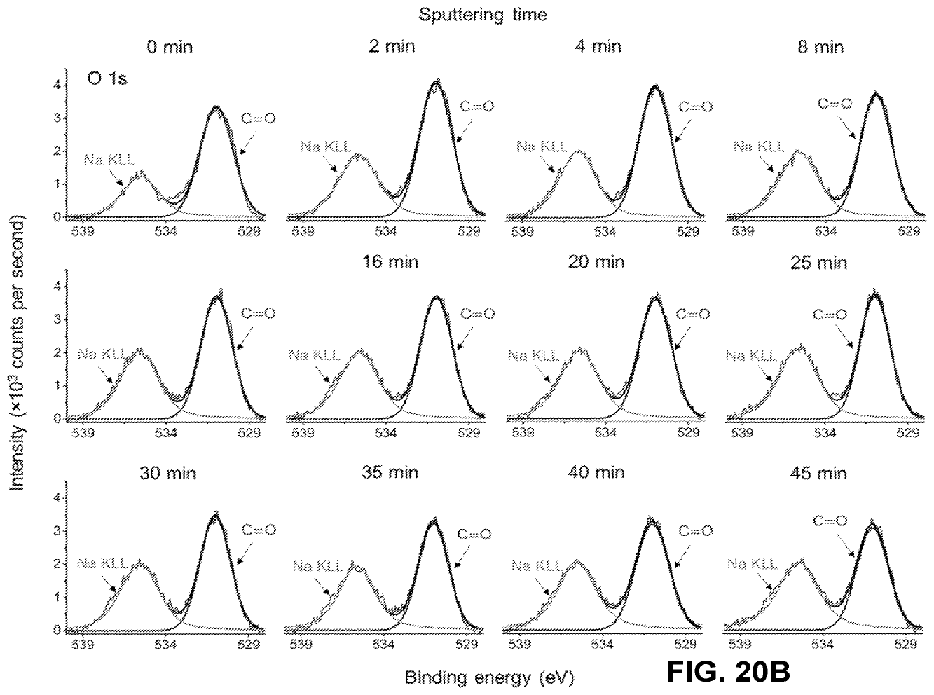

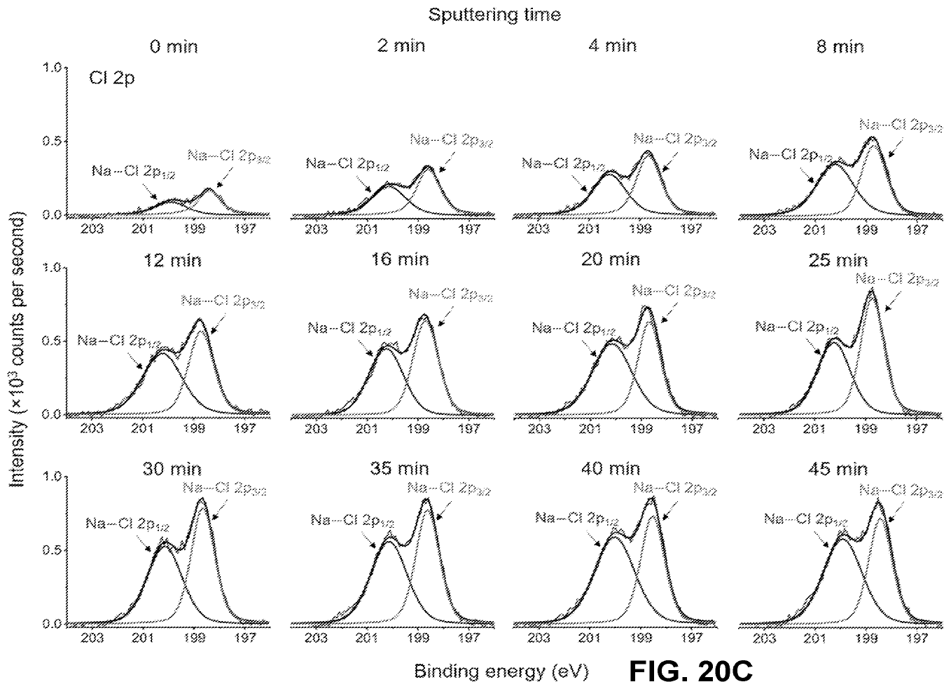

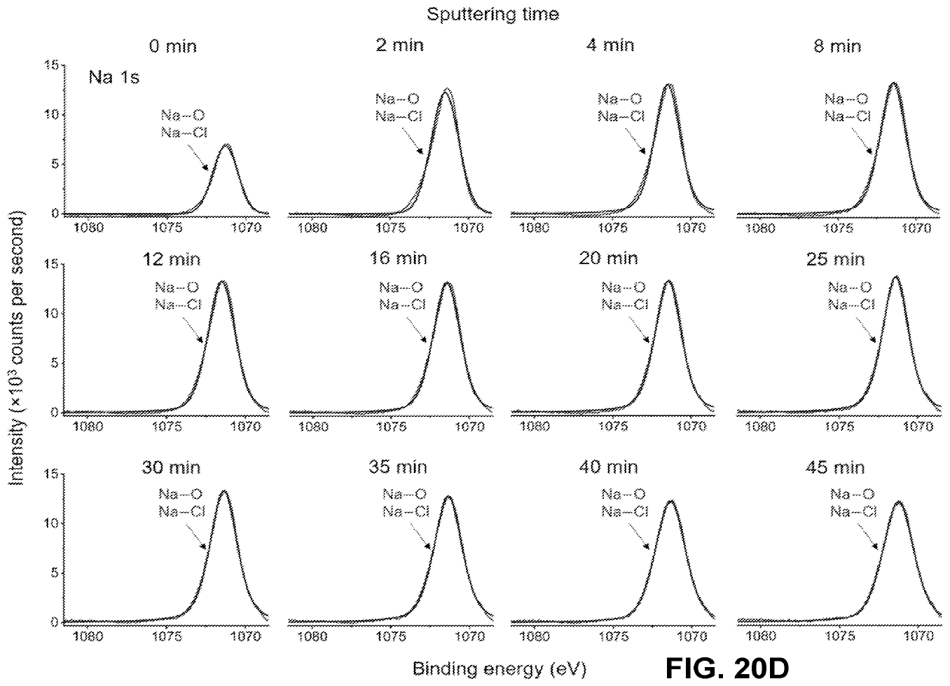

The non-porous Na deposits, as observed in the capillary cells, allow the XPS characterization of SEI layers on Na deposits, i.e. samples in the plated state. It is noteworthy that XPS characterization on deposited Na metal or Li metal were seldom performed before, since the porous nature of the deposited Na or Li metal (i.e. mixtures of metal and SEI) undermines the validity of the depth profiling. Consistent with the observation in the capillary cells (FIGS. 1(A-D), FIG. 2, FIGS. 4(A-B), and FIGS. 5(A-B)), the harvested electrode in the plated state was visually shiny-smooth. The dark regions in the inset photos of FIG. 11D and FIG. 11E are reflections of the stainless-steel walls of the glove box. As shown in FIG. 11(D-F), regardless of the plating time, i.e. the thickness of deposited Na metal, elements from the electrolyte always decay to the negligible level in about 20 minutes. The sputtering time to reach pure Na in plated samples is notably longer than the time to reach Cu in the stripped samples, yet independent from the thickness of the Na deposits. As supported by a control experiment on pristine Na sample (FIG. 19), this longer sputtering time is attributable to the porous oxidized layer formed on the Na deposits during the sample transfer and XPS characterization process. Beneath this top layer, however, the results confirm that the deposited Na metal is indeed nearly 100% pure Na without other elements. As another control experiment demonstrating the impact of the porous structure, the XPS spectra from the plated-state samples obtained in NaClO₄-diglyme electrolyte always show the uniform elemental distribution along the depth, without the Na plasmon peaks even after 45 minutes of sputtering (FIGS. 20(A-D)). Indeed, the porous Na-SEI composite structures accumulate to a considerable thickness as clearly seen in FIG. 10A. Scanning electron microscope (SEM) images in FIGS. 11(A-I) clearly reveal that the deposits of Na obtained in NaPF₆-diglyme electrolyte are continuous (FIG. 11G and FIG. 11H), while those obtained in NaClO₄-diglyme electrolyte show clear voids between metal filaments (FIG. 11I). As described herein, continuous deposits have no voids between metal filaments (i.e., continuous deposits are void-free; continuous deposition is void-free), and continuous surfaces are surfaces without crevices (i.e., a continuous surface is crevice-free).

The above results obtained at under-limiting current densities suggest that the SEI layers on Na in NaPF₆-glyme electrolytes do not hinder the formation of shiny-smooth Na deposits, unlike their Li counterparts that induce root-growing whiskers. While the lack of SEI has been confirmed recently on graphite electrode in glyme-based electrolytes for Na intercalation, the XPS results disclosed herein suggest the existence of a nanometer-thin layer on the Na deposits with typical chemical constituents of SEI.

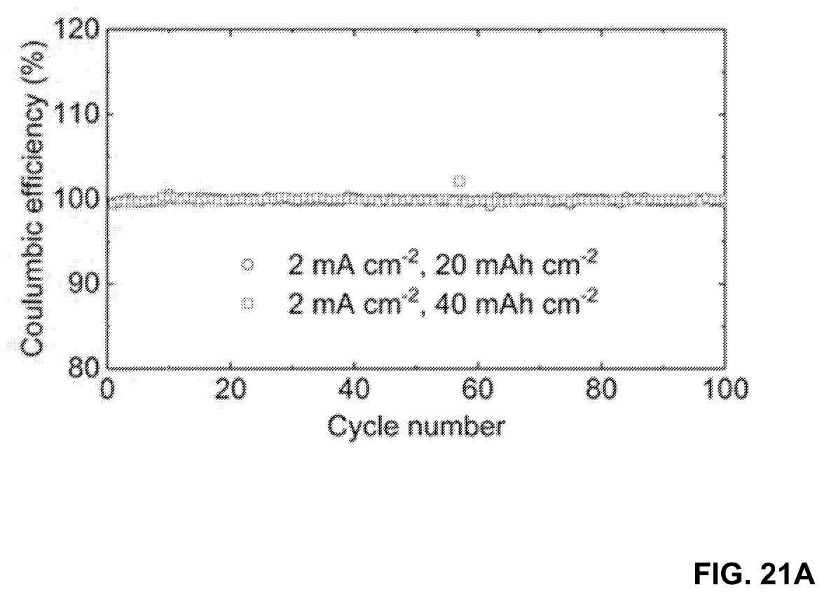

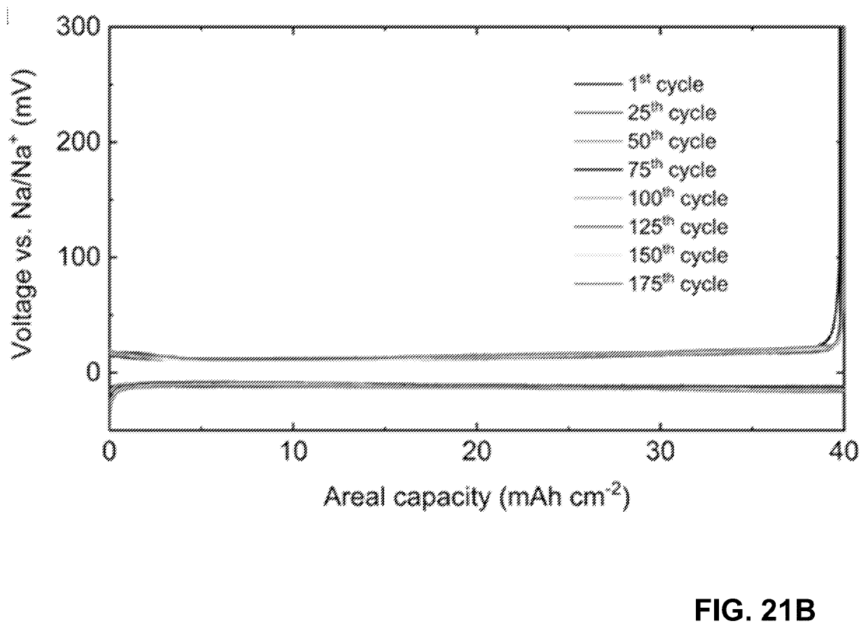

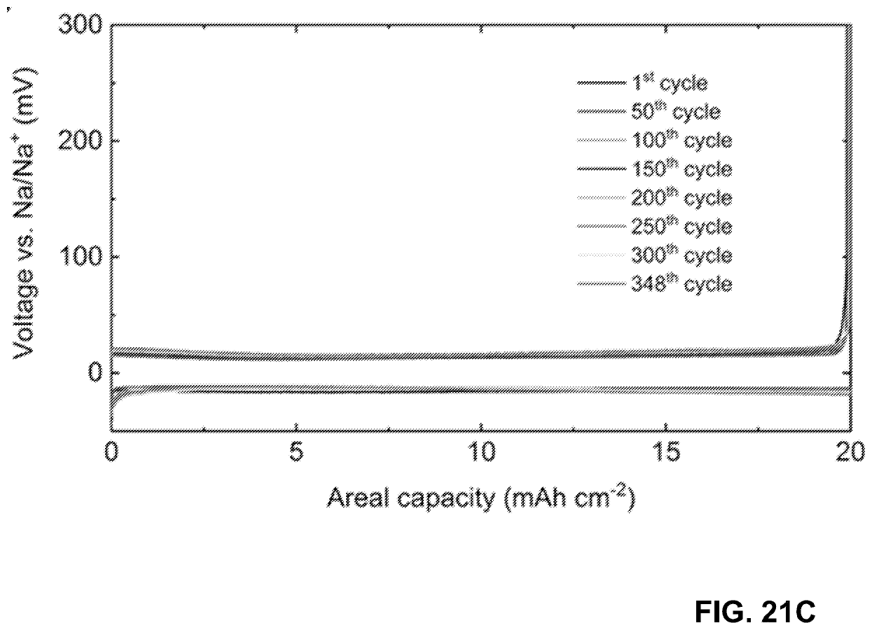

Cycling performance of half and full cells. Discovery of the shiny-smooth Na surface and lack of SEI accumulation indicates the possibility of high Coulombic efficiency in practical Na metal cells. Cu|Na half-cells were first assembled to test the Coulombic efficiency in galvanostatic cycling experiments with high current densities and areal capacities. At a current density of 2 mA cm⁻², a near-100% Coulombic efficiency was obtained for extreme areal capacities of 20 mAh cm⁻² and 40 mAh cm⁻² (FIG. 21A). For the case of 40 mAh cm⁻², the counter electrode was almost fully depleted. Detailed voltage responses are summarized in FIGS. 21B and 21C. It is worth mentioning that the occasional fluctuations of the Coulombic efficiency are attributable to the dynamic heterogeneity induced at this high current density when the plated Na is being completely stripped from the Cu current collector at the end of each cycle. The near-unity Coulombic efficiency at these extremely high areal capacities corroborates the ideal reversibility of this system, which agrees with embodiments and examples disclosed herein that only a very thin SEI layer was initially formed and no SEI was accumulated.

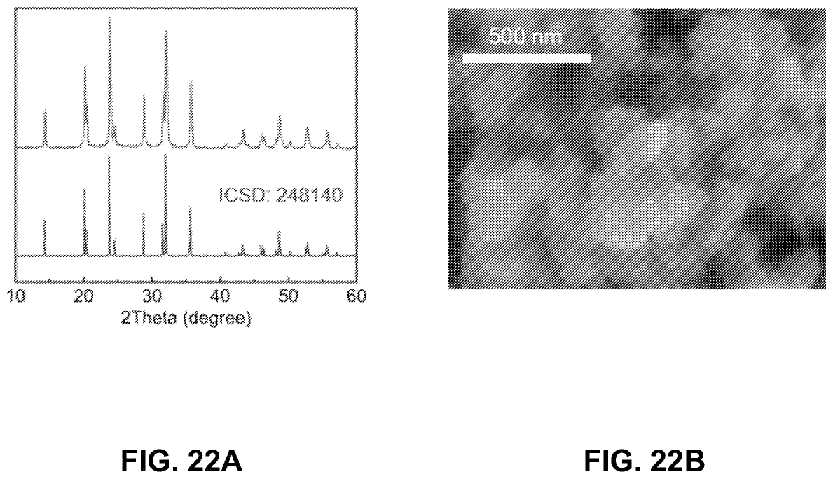

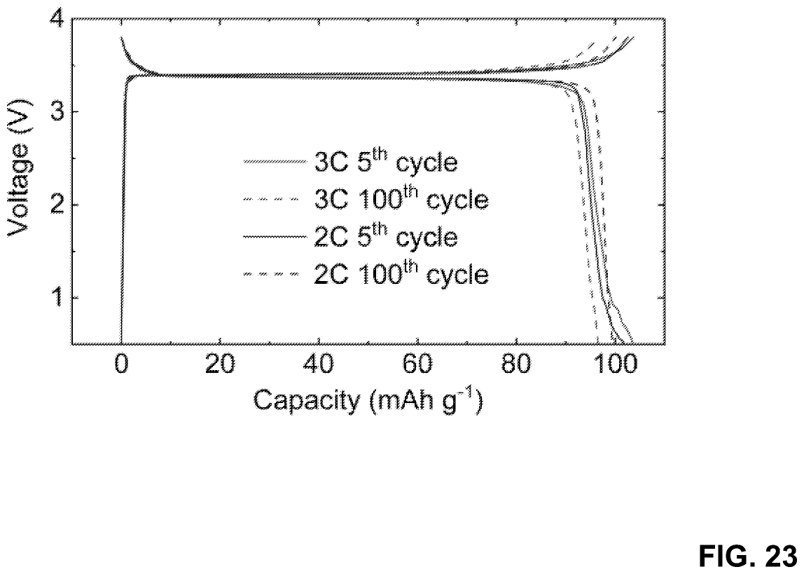

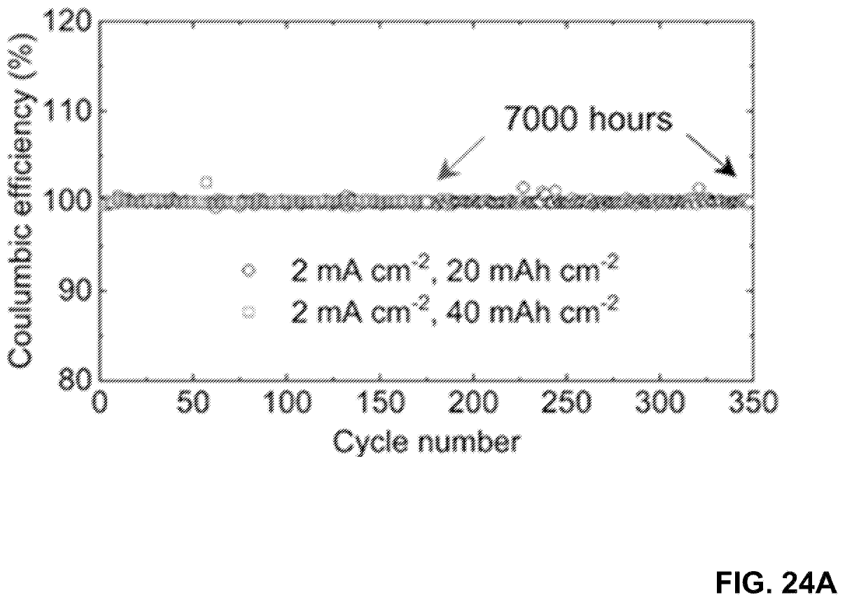

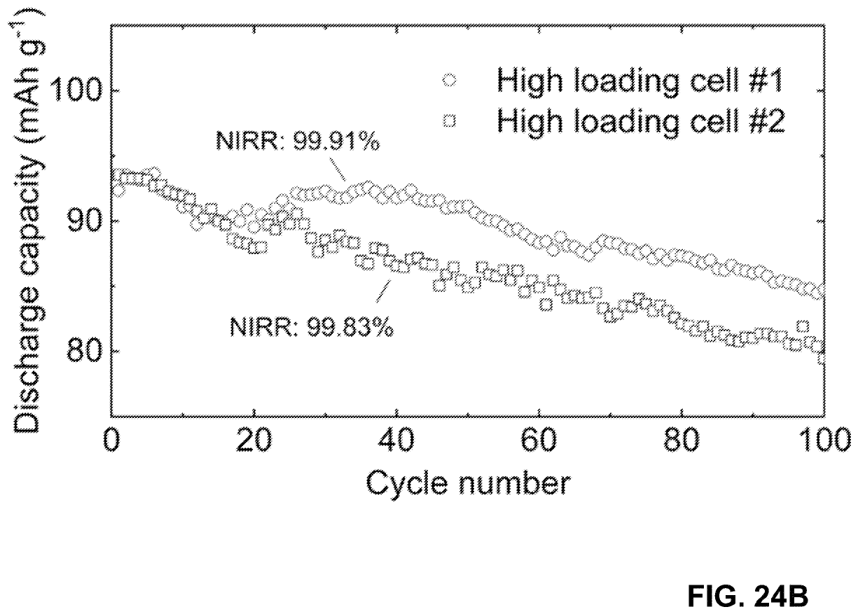

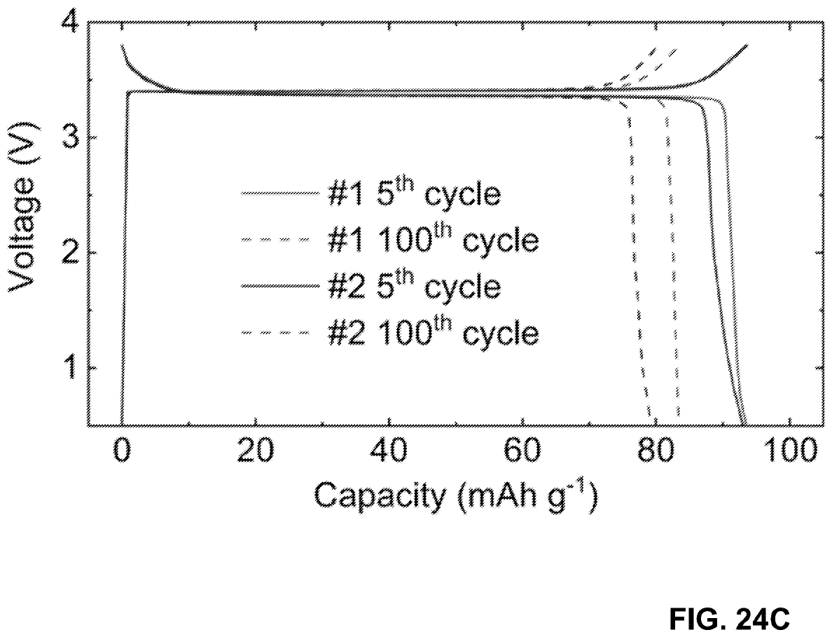

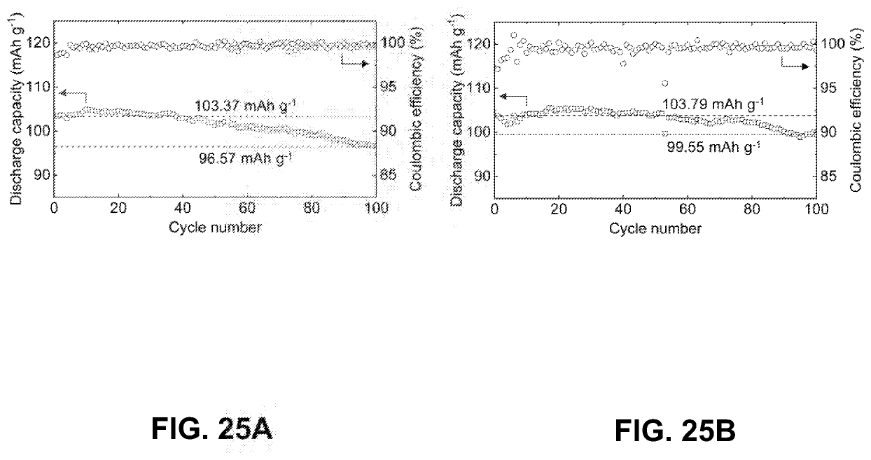

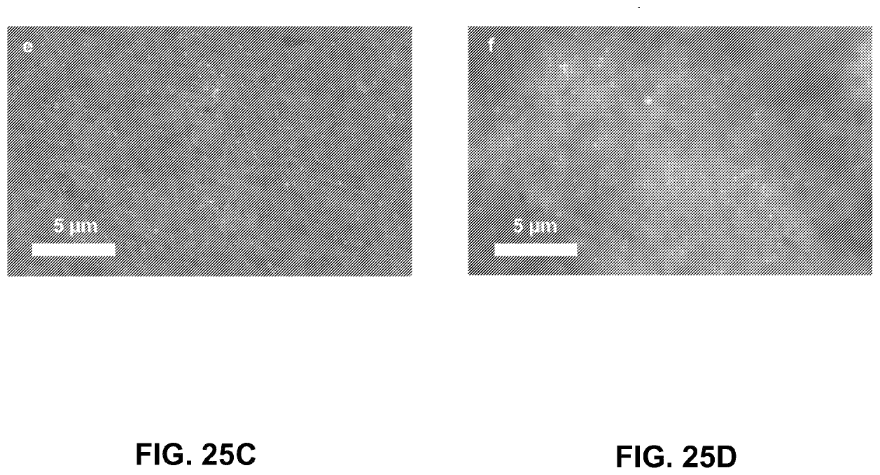

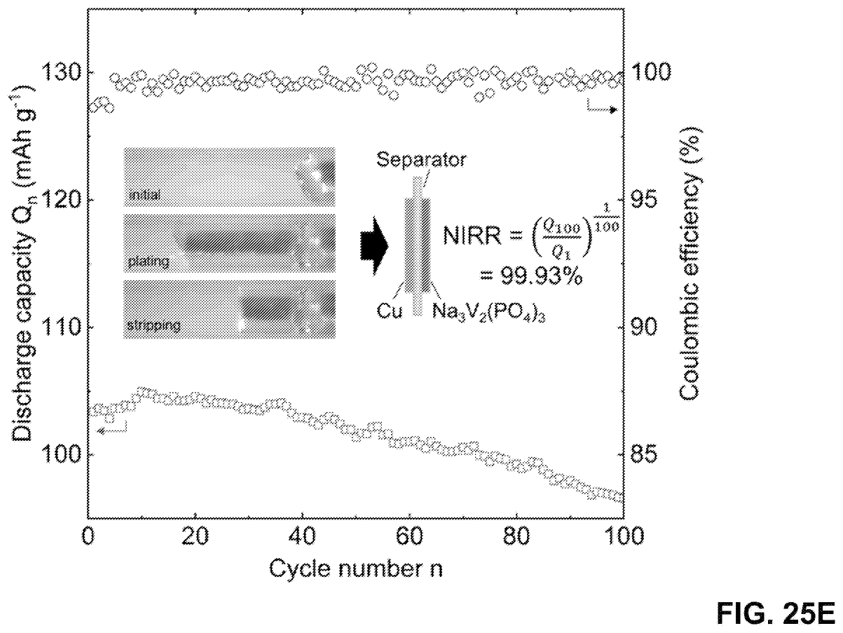

Nano-sized Na₃V₂(PO₄)₃(NVP), a promising high-voltage high-stability Na-intercalation cathode material, was synthesized to fabricate the anode-free full cells with the bare Cu current collector on the anode side (Cu|NVP). The Na₃V₂(PO₄)₃(NVP) nanomaterial was used herein as an unmodified metal substrate for fabricating the rechargeable anode-free sodium metal batteries of the present disclosure. XRD and SEM details of the NVP material are shown in FIGS. 22(A-B). As demonstrated in FIG. 23, the NVP cathode exhibited a flat voltage plateau at 3.4V, with stable cycling performance (FIGS. 24A, 24B, and 24C). NVP loading is approximately 6.2 mg cm⁻² for both cells, yielding the similar initial specific capacity of around 93 mAh g⁻¹ at 2C rate (1 mA cm⁻²), and the similarly high NIRR of 99.91% and 99.83%. The anode-free Cu|NVP full cell disclosed herein achieved an initial specific capacity of 103.37 mAh g⁻¹ during 3C (0.75 mA cm⁻²) charge-discharge cycling, i.e. 87.6% of the theoretical specific capacity of NVP, consistent with the literature. After 100 cycles, the cell still delivers 96.57 mAh g⁻¹ specific capacity, which is 93.4% of the initial specific capacity (FIG. 25A; see also FIG. 25E). Since the Coulombic efficiency includes charge dissipation due to other side reactions, Na inventory retention rate (NIRR) and Li inventory retention rate (LIRR) are used to better capture the degradation process of anode-free full cells. It is not uncommon that when the Coulombic efficiencies are around 99%, the NIRR or LIRR reach a higher value close to 99.8%. Using the formula 100%×(Qₙ/Qᵢₙᵢₜᵢₐₗ)^{1/n1}=NIRR, the NIRR of the full cell at 3C is 99.93%, higher than published anode-free Na full cells. Even in embodiments using the maximum capacity of 104.94 mAh g⁻¹ at the 10^{th} cycle as the “initial” capacity, the capacity retention after 90 cycles is still 92.0%, yielding a NIRR of 99.91%. The NIRR of the full cell at 2C is even higher, reaching 99.96% per cycle in 100 cycles (FIG. 25B). Na deposits in the Cu|Na half-cell retain their flatness after 100 cycles (FIG. 25C). Those harvested from the Cu|NVP anode-free full cells with the same cycling condition also appear continuous after 100 cycles (FIG. 25D).

The gravimetric energy density of the anode-free NVP cell at 3C (334.7 Wh kg_{NVP}⁻¹) is comparable to the theoretical energy densities of successful Li-ion batteries, e.g. 385.7 Wh kg_{Graphite+LiFePO4}⁻¹ from the Graphite|LiFePO₄ battery. Still, the abundant natural resources of Na and the lack of processing cost on the anode make the anode-free Na full cells a more sustainable and economical option for energy storage applications.

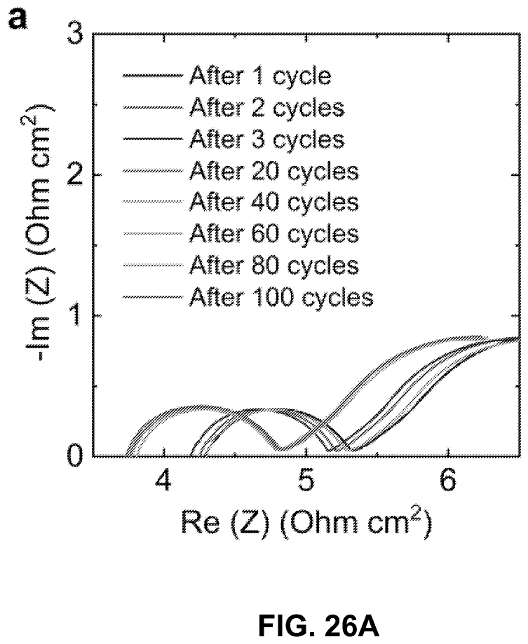

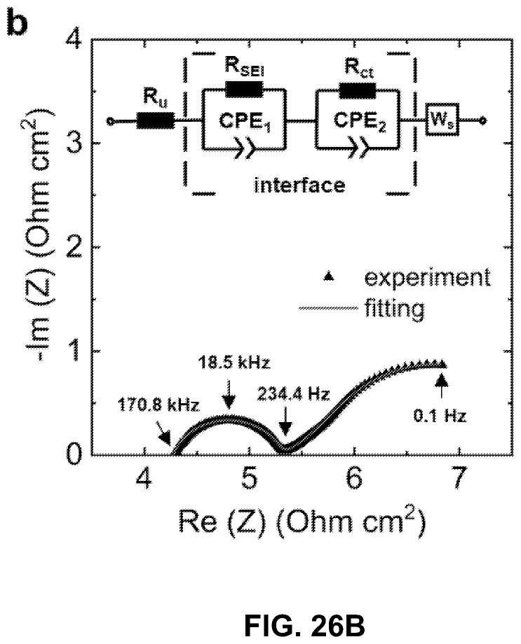

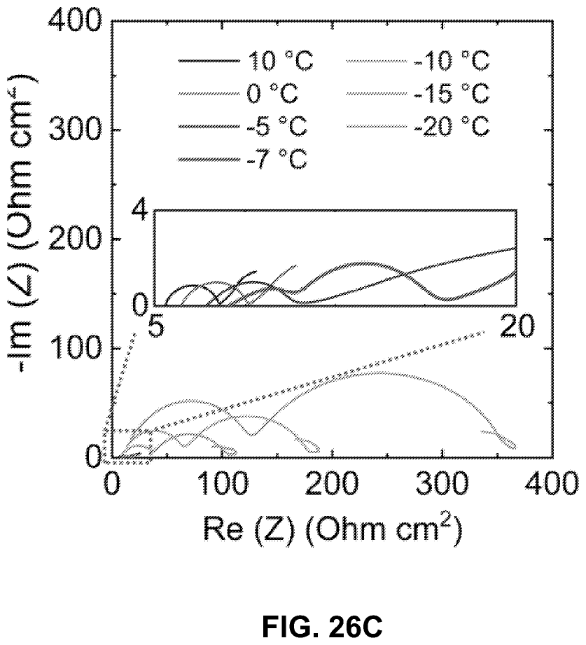

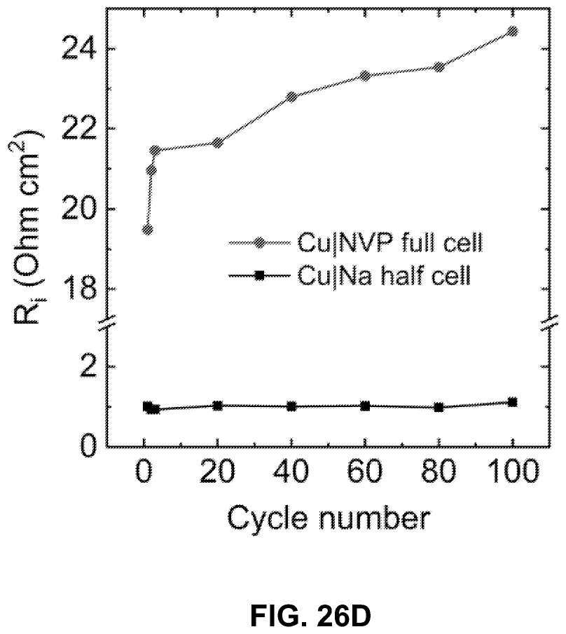

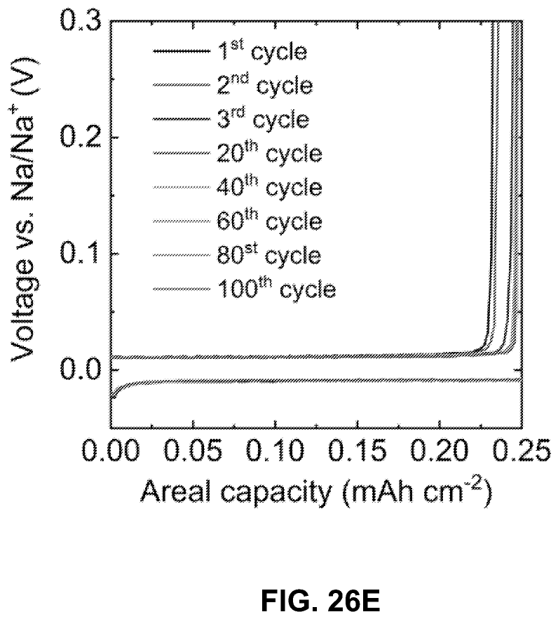

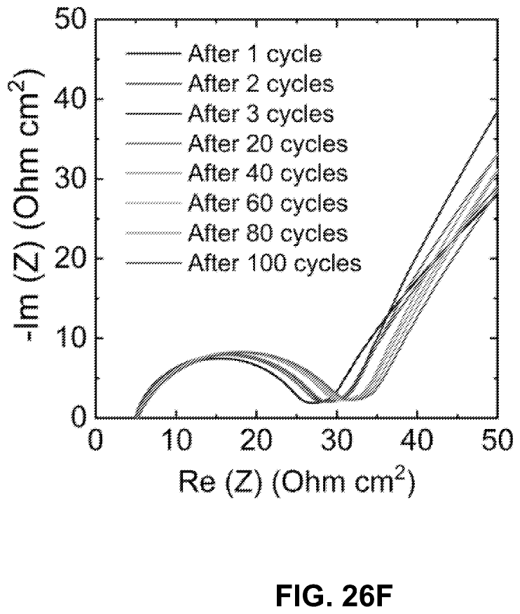

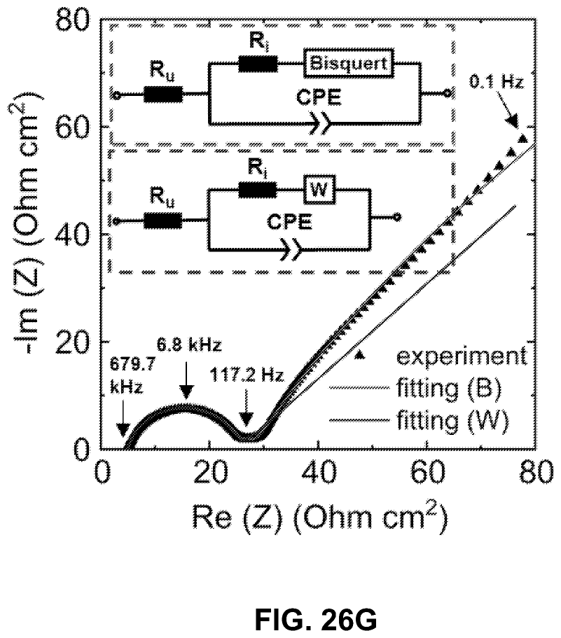

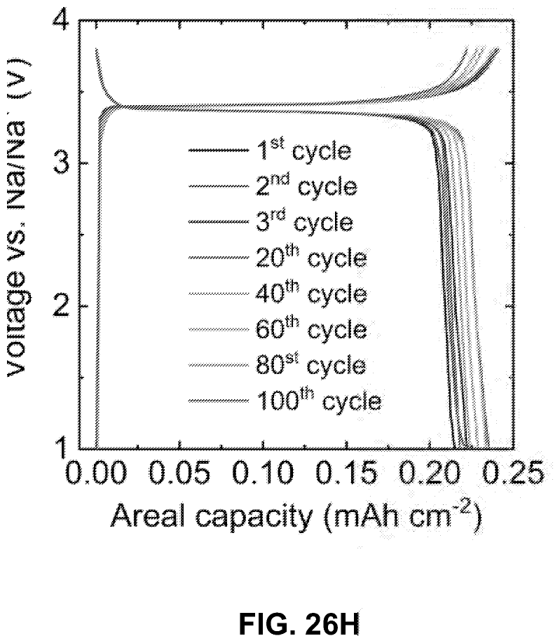

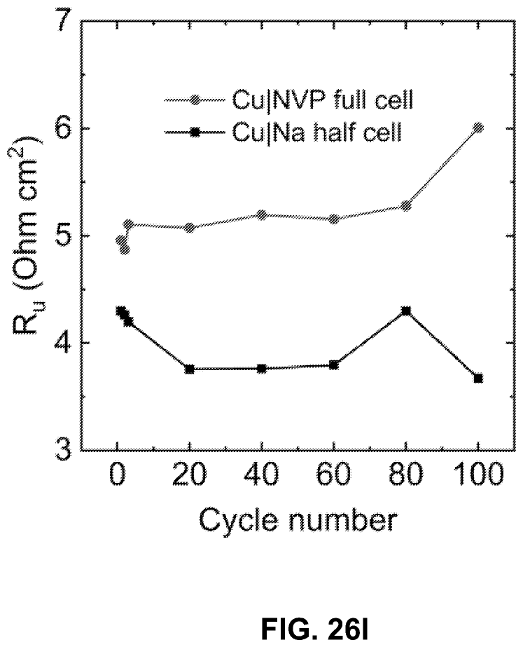

Impedance diagnosis of half and full cells. To better understand the degradation and roles of SEI evolution on anode and CEI on the cathode, EIS tests were further performed with both the Cu|Na half-cells and the anode-free Cu|NVP full cells. All cells were cycled at the same current density (3C, 0.75 mA cm⁻²) and same nominal capacities (0.25 mAh cm⁻²). The Nyquist plot of EIS spectra from the half-cells after different numbers of cycles (FIG. 26A) clearly reveal a nearly perfect semicircle followed by a finite length Warburg behavior, consistent with the reported EIS results of Li|Li and Na|Na symmetric cells. While the semicircle is routinely attributed as the charge transfer process, the characteristic frequency at the apex (ω=18.5 kHz) suggests that it is actually from both the SEI and charge transfer processes. As shown in FIG. 26B, with the diameter of the semicircle as the resistance across the interface (R=0.89Ω, half-cell electrode area=1.13 cm⁻²), the capacitance responsible for this semicircle is determined as C=1/ωR=61 F. Considering that the charges at the electrolyte|SEI interface and the SEI|electrode interface form a double-plate capacitor, the dielectric constant for the SEI (ϵ_{SEI}) is then determined by using the general formula C=A_{ϵϵ0}/l, where A=1.13 cm⁻² is the area of the plated Na electrode, 1≈4 nm is the estimated thickness of the SEI based on the XPS results using a 1 nm per min conversion rate, and ϵ₀ is the permittivity of vacuum. The obtained dielectric constant ϵ=244 is in the same order of magnitude of the dielectric constants for SEI on Li anode and for ion-conducting polymer electrolytes. On the one hand, assuming that there is no SEI, and Na ions come to the electrode surface for a direct contact before charge transfer, a double-layer capacitor with a thickness same as the ionic radius of Na (0.102 nm) is formed. Using this new thickness, another dielectric constant is calculated to be 6.2, very close to the reported values (˜7.45) for diglyme. Therefore, while just a single R-C pair can be used to perfectly fit the semicircle, there are actually two interfacial processes as indicated by the equivalent circuit model shown in FIG. 26B. The two interfacial capacitors are deconvoluted at lower temperatures. As shown in FIG. 26C, the single semicircle clearly deconvolutes into two distinct yet connected semicircles when the temperature is lower than −7° C., consistent with the general expectation that properties of solid electrolyte (SEI) and liquid electrolyte have different dependence on temperature. Nevertheless, the interfacial impedance at room temperature, no matter it is from SEI or charge transfer, remains very low and nearly constant (FIG. 26D), which is another compelling confirmation that the initial SEI did not thicken nor accumulate upon cycling. The lack of apparent change of the overpotential in the voltage profiles (FIG. 26E) during cycling is yet another piece of evidence that SEI did not thicken or accumulate.

The impedance spectra of full cells show similar behavior (FIG. 26F and FIG. 26G) with a nearly perfect semicircle followed by a Warburg tail. In some embodiments, the low frequency part is explained by different variants of the Warburg impedance, e.g. the Bisquert element derived from a modified transmission line model to account for distributed reactions. However, these choices do not affect the fitting results for the semicircle in the medium-to-high frequency range responsible for the interfacial processes. The decrease of the frequency at the apex, from 18.5 kHz for half-cell shown in FIG. 26B to 6.8 kHz for full cell shown in FIG. 26G, and the increase of the diameter of the semicircle from 1Ω cm⁻² to >19Ω cm⁻², are clear signs that additional interfacial processes from the cathode are now coupled into the semicircle. As compared in FIG. 26D and FIG. 261, the interfacial resistance for the full cell steadily grows during cycling, which is attributable to the evolution of the cathode electrolyte interphase (CEI) layers. Still, it is noteworthy that the increase of interfacial impedance of full cell is very slow, and no substantial increase of overpotential was found in the voltage profile (FIG. 26H) until toward the end of each discharge.

### DISCUSSION

Recent theoretical studies support a lack of repeated formation or accumulation of SEI. For instance, density functional theory (DFT) calculations found that the reduction potentials of possible complexes formed in the NaPF₆-diglyme electrolyte are all lower than the redox potential of Na/Na+, suggesting clearly that this electrolyte is compatible with Na metal. Chemical stability was investigated by immersing Na metal in the electrolyte for five days. The gas evolution, however, was attributed to the side reaction with PTFE in the pressure cell, rather than the reduction of the solvent. The moisture level in their electrolytes was determined to be lower than 20 ppm. As a further example, molecular dynamic simulations discovered that NaPF₆-glyme electrolytes will form an optimal solvation structure, where the PF₆⁻ anions will be kept far away from the negatively charged electrode surface, minimizing the corrosion effects on Na deposits. Consequently, results demonstrating no repeated formation of SEI on Na metal during cycling are well supported by previous theoretical predictions.

In reality, electrodes do not work in a perfect environment, nor under ideal conditions. The spatiotemporal heterogeneities induced by localized current or electric field easily drive the system to far-from-equilibrium conditions, where scattered yet occasional reduction reactions of the electrolyte still occur. In addition, the trace amount of impurities, e.g. water, affect the SEI formation. In capillary cell experiments, the amount of water in the electrolyte must be carefully controlled. With a water content higher than 50 ppm, small gas bubbles of pico-liter size (i.e. diameter of >20 μm) were frequently observed that interfered with the smooth growths of Na. At a water level of 20-30 ppm, gas bubbles are avoidable, however ingot-type deposits with shiny-smooth surface cannot be guaranteed. In order to obtain the shiny-smooth ingot-type Na presented herein, it was necessary to control the water content to be lower than 10 ppm. Regarding investigation of the effect of water in various glyme electrolytes, the trace amount of water in the range of 10-50 ppm in the LiPF₆ electrolyte has been confirmed to be able to significantly change the SEI and morphology of Li metal anodes.

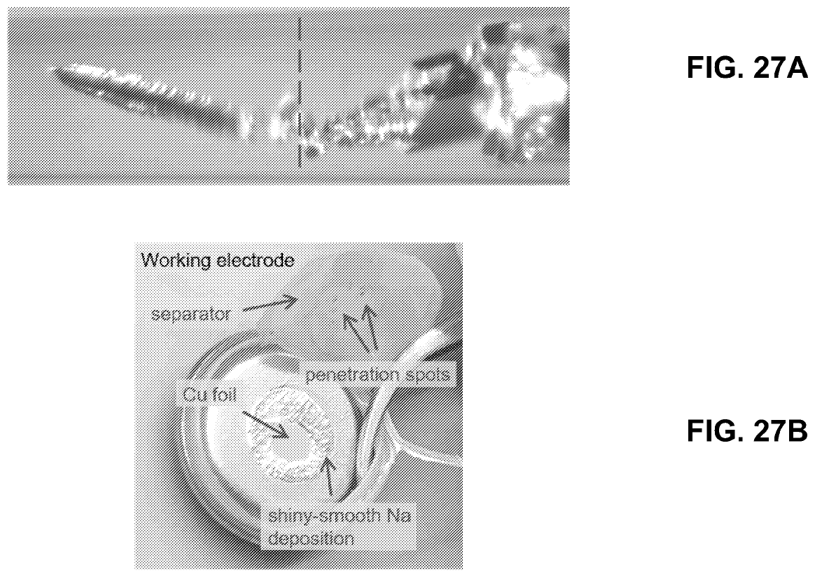

All experiments described herein adopted under-limiting current densities, at which non-porous Na ingots were obtained in both the capillary and coin cells. However, dendritic growth is still possible when diffusion limitation is reached. A typical operando snapshot of electroplating at an over-limiting current density (FIG. 27A) clearly shows the transition of growth mechanism, and enables further discussion on diffusion-limited tip-growing Na dendrites. It is also important to point out that, when relatively high current densities are applied, the macroscopic heterogeneous separatorlelectrode interface, not the homogeneous electrolytelelectrode interface, naturally selects a few penetration channels (black spots in FIG. 27B), through which the ionic flux must have been strongly localized to enable the metal penetration. Within these isolated channels, over-limiting current densities and diffusion-limited tip-growing dendrites were triggered.

The results disclosed herein demonstrated a successful comprehensive solution to both the non-uniform growths and the low Coulombic efficiency of Na metal anodes. Compared with the latest reports using diglyme electrolytes for Na metal battery, excess Na was not assembled in the coin cell for full cell cycling tests. Compared with previous anode-free Na metal batteries, an additional nano-carbon nucleation layer was not engineered for the present disclosure. Embodiments described herein used the simplest bare copper foil. The near-unity Coulombic efficiency achieved in Na metal half-cells working at extreme conditions, as well as the impedance diagnosis upon cycling, suggest that the performance degradation of the anode-free full cells was dominated by the cathode. The NVP cathode exhibits excellent stability in the Na|NVP half-cells (FIG. 24A). The degradation becomes more obvious in the anode-free Cu|NVP full cells, in which the Na loss to CEI is no longer compensated by excess Na. To fully exploit the ideal stability of the metal anode, high-loading Na-ion cathodes must be developed. FIGS. 24B and 24C demonstrate the excellent cycling efficiency of anode-free full cells with thicker NVP electrodes (˜6.2 mg cm⁻²). However, preparing ultra-thick electrodes with a loading >10 mg cm⁻² without cracking, yet with satisfactory tortuosity, is challenging. In some embodiments, fine-tuning the chemistry and viscosity of the solvents for making the slurry and controlling the drying process realizes high-capacity high-power anode-free Na batteries that outperform Li-ion batteries.

### CONCLUSION

With the glass capillary cells described herein, the self-modulated shiny-smooth non-porous growth of an alkali metal ingot in liquid electrolytes was demonstrated herein for the first time, which are cycled reversibly without producing Na whiskers, mosses, gas bubbles or disconnected Na particles. Contradictory to the prevailing understandings on SEIs, it was discovered for embodiments disclosed herein that there was no repeated SEI formation during cycling, despite the significant volume change of the metal anode during cycling. The very initial SEI components detected by XPS depth profiling do not thicken or accumulate regardless of the deposition thickness or cycling history of the Na electrodes. The present disclosure is well supported by recent theoretical studies indicating that the NaPF₆-diglyme electrolyte is thermodynamically stable against Na metal. The simplest anode-free Na full cells in the configuration of Cu|Na₃V₂(PO₄)₃, without excess Na metal or special modifications of the bare copper current collector, exhibit stable cycling performance. A Na inventory retention rate of 99.93% per cycle during galvanostatic cycling at 3C (0.75 mA cm⁻²) has been achieved. The possibility and significance of achieving the ideal dynamic interfacial stability of an alkali metal in liquid electrolytes is disclosed herein, for which the operando microcapillary cell experiment provides the necessary and effective method to identify the unexpected performance-limiting subtleties difficult to detect by previous methods. In some embodiments, solvation structures and interfacial reaction kinetics further enables similar shiny-smooth non-porous growths of other metal anodes in liquid electrolytes.

### MATERIALS AND METHODS

Materials. 1,2-Dimethoxyethane (monoglyme, anhydrous, 99.5%), diethylene glycol dimethyl ether (diglyme, anhydrous, 99.5%), triethylene glycol dimethyl ether (triglyme, 99%), tetraethylene glycol dimethyl ether (tetraglyme, 99%), ethylene carbonate (EC, anhydrous, 99%), dimethyl carbonate (DMC, anhydrous, >99%), sodium cubes (99.9%), vanadium oxide (V₂O₅, 99.6%), ammonium phosphate monobasic (NH₄H₂PO₄, anhydrous, >98%), sodium carbonate (Na₂CO₃, anhydrous, >99.5%), L-ascorbic acid (anhydrous, >99%), poly(ethylene glycol) (PEO, Mₙ 400), N-Methyl-2-pyrrolidinone (NMP, 99%) were purchased from Sigma-Aldrich. All the solvents were dried using molecular sieves for at least 3 days before use. Sodium hexafluorophosphate (NaPF₆, >99%, Alfa Aesar), sodium perchlorate (NaClO₄, anhydrous, ACS reagent, Acros Organics) were purchased from Fisher Scientific. Salts were dried at 100° C. for 48 hours before use. Water content was measured by a coulometric Karl Fischer titrator (Metrohm). 0.01-inch diameter stainless steel wires, 0.03-inch thickness polyvinylidene fluoride (PVDF) sheets were purchased from McMaster-Carr. The G-1 glass capillaries were purchased from Narishige Co., Ltd. Polypropylene-Polyethylene-Polypropylene (PP-PE-PP) tri-layer battery separator (Celgard 2325, 25 μm thickness), copper foil for battery anode substrate (9 μm thickness), aluminum foil for battery cathode substrate (15 μm thickness), conductive acetylene black, HSV900 PVDF binder were purchased from MTI Corporation.

Synthesis. The synthesis process of nano-sized Na₃V₂(PO₄)₃(NVP) follows the reported hydrothermal assisted sol-gel method. V₂O₅, NH₄H₂PO₄, Na₂CO₃, L-ascorbic acid and PEO 400 were mixed with the desired molar ratio in distilled water. The mixture was kept at 180° C. in an autoclave for 40 h, followed by open heating at 95° C. to evaporate the water. The obtained precursor was preheated at 350° C. for 4 h and then calcinated at 750° C. for 6 h in the flowing Ar atmosphere to obtain the final product.

Electrode preparation. Nano-sized NVP, conductive acetylene black and PVDF binder were thoroughly mixed into slurry with NMP at a weight ratio of 8:1:1. The slurry was cast onto the aluminum foil and dried at 120° C. overnight before cutting into disk electrodes. The diameter of the disk electrode is 8 mm, i.e. a geometric area of 0.5 cm⁻². The mass loading of NVP is around 2.3 mg cm⁻² for the tests shown in FIG. 23, FIG. 24A, FIGS. 25(A-D), and FIGS. 26(A-I), and around 6.2 mg cm⁻² for the high-loading tests shown in FIGS. 24B and 24C. The diameter of the Cu current collector is 12 mm. In Cu|Na half-cells, diameters of the Na electrode and the Cu current collector are 12 mm, i.e. a geometric area of 1.13 cm⁻².

Cells fabrication and electrochemical testing. All cells were assembled in an Ar-filled glove box with H₂O and O₂ concentration <0.5 ppm. The glass capillaries were pulled 7 mm longer with a vertical type micropipette puller (PC-10, Narishige Co., Ltd). The pulled capillary was fixed onto a piece of glass slide using epoxy. Electrolytes were filled in the capillary by the capillary effect from one side. Two pieces of sodium were then pushed by stainless steel wires to form a Na|Na symmetric cell. The separation between two electrodes varies from ˜380 m to ˜3500 m depending on the aims of experiments. In situ images were captured by an optical microscope (MU500, AmScope). 2025-type coin cells were fabricated for preparing the samples for XPS characterization and for long-term cycling tests. The Cu|Na half-cells were assembled with the configuration of Culseparator|Na, where one layer of the PP-PE-PP tri-layer separator was used. The Cu|NVP anode-free full cells with the configuration of Culseparator|NVP were also constructed in 2025-type coin cells. Electrochemical tests were conducted with a Gamry potentiostat (Reference 600+, Gamry Instruments), an Arbin battery tester (LBT 20084, Arbin Instruments) and a Land battery testing system (CT3001A, Lanhe instruments). The impedance tests were performed at deposited states with a frequency range from 5 MHz to 0.1 Hz.

Characterization. For XPS characterization, Cu|Na sandwich cells were disassembled after cycling at 0.5 mA cm⁻² for 1 mAh cm⁻² (without considering the porosity) for desired cycle numbers to examine the SEI at deposited or stripped states. Samples were washed in diglyme for three times before fixing onto the XPS holder. The standard washing procedure is to soak the sample in 10 mL of diglyme solvent for 30 seconds with gentle shaking. For the “thoroughly rinsed” sample, in addition to the standard procedure, the sample was laid flat and washed by dispensing about 1 mL diglyme from a plastic dropper. The XPS holder was transferred into the chamber within an argon-filled XPS transfer kit. XPS characterization was performed using Physical Electronics 5000 VersaProbe II Scanning ESCA Microprobe. The depth profiling was carried out by the argon-ion sputtering at 2 kV and 1 μA at a 2×2 mm area. For XRD characterization, Bruker D8 advance X-ray diffractometer was utilized. Si crystal zero diffraction plate purchased from MTI Corporation was used as a powder sample holder. For SEM imaging, Thermofisher Quattro S environmental scanning electron microscope was utilized.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that vary depending upon the desired properties sought to be obtained by a particular embodiment. In some embodiments, the numerical parameters are be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) are construed to cover both the singular and the plural, unless specifically noted otherwise. In some embodiments, the term “or” as used herein, including the claims, is used to mean “and/or” unless explicitly indicated to refer to alternatives only or to refer to the alternatives that are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and may also cover other unlisted steps. Similarly, any composition or device that “comprises,” “has” or “includes” one or more features is not limited to possessing only those one or more features and may cover other unlisted features.

All methods described herein are performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member is referred to and claimed individually or in any combination with other members of the group or other elements found herein. One or more members of a group are included in, or deleted from, a group for reasons of convenience or patentability. When any such inclusion or deletion occurs, the specification is herein deemed to contain the group as modified thus fulfilling the written description of all Markush groups used in the appended claims.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments of the disclosure, but their usage does not delimit the disclosure, except as outlined in the claims.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A rechargeable anode-free sodium metal battery comprising:
a cathode substrate;
a cathode nanomaterial deposited onto the cathode substrate;
a nonaqueous electrolyte, wherein a total water content of the nonaqueous electrolyte is about 10 ppm or less; and
an anode substrate, wherein the anode substrate has no deposited material prior to battery recharge, and wherein the anode substrate comprises an ingot-type, non-porous sodium metal surface formed during battery recharge.

2. The battery of claim 1, wherein the cathode substrate is aluminum foil.

3. The battery of claim 1, wherein the cathode nanomaterial is Na₃V₂(PO₄)₃(NVP).

4. The battery of claim 1, wherein the nonaqueous electrolyte is a glyme electrolyte.

5. The battery of claim 4, wherein the glyme electrolyte comprises a NaPF₆-diglyme electrolyte.

6. The battery of claim 5, wherein a concentration of the NaPF₆-diglyme electrolyte is 1M.

7. The battery of claim 1, wherein the anode substrate is copper foil.

8. The battery of claim 1, further comprising a Polypropylene-Polyethylene-Polypropylene (PP-PE-PP) tri-layer battery separator.

9. A method for fabricating a rechargeable anode-free sodium metal battery, the method comprising:
depositing sodium metal onto an anode substrate during battery recharge from a nonaqueous electrolyte, wherein a total water content of the nonaqueous electrolyte is about 10 ppm or less; and
forming on the anode substrate a continuous, crevice-free, shiny-smooth, non-dendritic, and non-porous sodium metal surface.

10. The method of claim 9, wherein the anode substrate is copper foil.

11. The method of claim 9, wherein the nonaqueous electrolyte is a glyme electrolyte.

12. The method of claim 11, wherein the glyme electrolyte comprises a NaPF₆-diglyme electrolyte.

13. The method of claim 12, wherein a concentration of the NaPF₆-diglyme electrolyte is 1M.

14. A method for characterizing interfacial stability of an electrode, the method comprising:
filling a transparent capillary cell with nonaqueous electrolyte, wherein a total water content of the nonaqueous electrolyte is about 10 ppm or less;
adding sodium metal to the transparent capillary cell; and
applying one-way electroplating with at least one rest.

15. The method of claim 14, wherein the one-way electroplating is applied for at least about 10 hours.

16. The method of claim 14, wherein the at least one rest is applied for at least 8 hours.

17. The method of claim 14, wherein the at least one rest is applied for up to about 16 hours.

18. The method of claim 14, wherein the nonaqueous electrolyte is a glyme electrolyte.

19. The method of claim 18, wherein the glyme electrolyte comprises a NaPF₆-diglyme electrolyte.

20. The method of claim 14, wherein the one-way electroplating is applied from about 0.05 mA cm⁻² to about 2.25 mA cm⁻².
